(19) United States
(12) Patent Application Publication
(10) Pub. No.: US 2003/0144909 A1
(43) Pub. Date: Jul. 31, 2003

(54) Point-of-sale-activation device

(76) Inventors: Stephen C. Flaherty, Provo, UT (US); Paul C. Hickey, Cedar Hills, UT (US)

Correspondence Address: JOHN C. STRINGHAM, WORKMAN, NYDEGGER & SEELEY, 1000 Eagle Gate Tower, 60 East South Temple, Salt Lake City, UT, 84111, US

(21) Appl. No.: 10/350,198

(22) Filed: Jan. 23, 2003

Related U.S. Application Data
(60) Provisional application No. 60/353,069, filed on Jan. 30, 2002.

(51) Int. Cl. G06F 17/60

(52) U.S. Cl. 705/17

(57) ABSTRACT

A terminal is provided for implementing prepaid service transactions, facilitating employee training, and promoting products and services to consumers. The terminal can be employed in various environments and includes a keypad with number, function, and navigation keys. A thermal printer and magswipe card reader are also provided. Communication is implemented by hardwire or wireless connection using various communication methodologies and protocols. An interface display provided on the front of the permits users to interact with the terminal for purposes such as training, obtaining reports, and implementing prepaid service transactions. A programmable media display is mounted on the back of the terminal oriented and positioned in such a way as to be readily perceived by consumers or prospective consumers. The relatively large size of the media display, as well as its location, promotes ready perception and recognition by consumers and allows a variety of messages and information to be displayed.

### CROSS-REFERENCE TO RELATED APPLICATIONS

This application hereby claims priority to U.S. Provisional Patent Application Serial No. 60/353,069, entitled APPARATUS, METHOD AND SYSTEM FOR INFORMATION MANAGEMENT TOOL AND POINT OF SALE PREPAID SERVICES PLATFORM WITH JUST IN TIME INVENTORY FEATURES, INTERACTIVE TRAINING AND MEDIA DISPLAY, filed Jan. 30, 2002, and made a part hereof and incorporated herein in its entirety by this reference.

### BACKGROUND OF THE INVENTION

1. Field of the Invention

The present invention relates generally to prepaid services. More particularly, embodiments of the present invention relate to systems, devices, methods, and software for use in implementing point-of-sale prepaid service transactions.

2. Related Technology

Due to a variety of factors, overseas and domestic sales of mobile phones have increased dramatically in recent years. The relatively low cost of many mobile phones has played an important part in this growth in sales. Further, advances in technology, as well as the performance and features available in mobile phones, have also contributed significantly to increases in sales figures by broadening the appeal of mobile phones to a wider variety of consumers. By way of example, many mobile phones can now be used to explore the Internet, play video games, check movie listings, and send and receive text messages and email. Thus, the availability of such features has caused redefinition of the mobile phone from simply a communications device to a multi-purpose personal consumer electronics device.

In general, payment for mobile phone telephone services is structured in one of two ways. In the United States, the most common payment arrangement is where the subscriber pays a bill each month for services used. This arrangement is sometimes referred to as “postpaid” wireless service. Such postpaid wireless service payment arrangements are not readily available to all consumers who may desired wireless phone service however. For example, many consumers are denied conventional postpaid wireless service as a result of their poor credit history, or lack of credit history. Until relatively recently however, such consumers had no choice but to simply go without wireless phone service.

In recognition of this problem, other payment arrangements have been devised. Most notably, so-called “prepaid” wireless service payment plans have been developed that permit a consumer to pay for particular wireless phone services, such as a preset number of local calling minutes, in advance. In this example, once the prepaid minutes are used, the wireless phone service terminates and the user must purchase additional minutes. The prepaid approach to wireless service payment has a variety of benefits that make it attractive to many users.

For example, because payment is made in advance, the purchaser is not subjected to a credit check. Further, the user has relatively better control over wireless service expenditures because the service is designed to terminate when all the purchased minutes have been expended. This feature makes prepaid wireless service attractive to consumers having a limited budget, such as students or those on a fixed income. Additionally, prepaid wireless service customers are generally not required to sign a contract concerning the service. This feature is particularly attractive as it is often quite difficult, and expensive, for a postpaid wireless service customer to terminate a service contract before the expiration date of the contract. Yet another feature that many prepaid wireless service consumers find attractive is that the purchase of prepaid wireless services is made anonymously, and the consumer thereby avoids exposure to unwanted marketing efforts, promotions, and other activities that may be offered by the wireless service vendor.

As a result of these and other features, prepaid wireless service plans have become increasingly popular and many industry experts expect significant growth in the demand for such plans. This is particularly the case in the United States where the sale of prepaid plans have generally lagged sales of postpaid plans. At the same time, the market in the United States for postpaid plans has been deeply penetrated. Consequently, there is room for; substantial growth in the sale of prepaid plans in the Unites States.

The prepaid services market is not limited to mobile telephone service however, various other prepaid services can be purchased as well. For example, some vendors now offer unlimited prepaid local telephone service, sometimes referred to as “home dial tone,” that can be purchased on a monthly, or other, basis. Many of the features that make prepaid wireless attractive apply as well to home dial tone services. Thus, home dial tone services can be purchased and used without requiring credit checks or contracts. Similar to the case of prepaid wireless plans, there is room for significant growth in the home dial tone and other prepaid services markets.

In light of the increasing popularity of prepaid service plans such as those described above, and others, various systems and methods have been devised to replenish depleted prepaid services. One systems that is currently in widespread use involves the use of voucher cards, also sometimes referred to as “scratch cards.” Such voucher cards typically have the size and shape of a credit card format and are generally constructed of either plastic or cardboard. Typically, each prepaid card includes some type of code or identification number that is protected by a scratch panel or high security label. After the card has been purchased, the consumer removes the scratch panel or label and recites the revealed code to the user accounts office. At that time, the prepaid service credit can then be posted to the card account and is available for use by the consumer.

As suggested by the foregoing however, the voucher card system, and similar systems, present a variety of problems. By way of example, voucher cards are readily susceptible to theft as a result of their small size. Once the voucher card is stolen, it is a simple matter for the thief to remove the scratch panel from the card and activate and use the prepaid services

Voucher cards are also problematic because they impose inventory costs on the retailer through which they are purchased. Moreover, voucher cards are subject to out-of-stock situations as well. In particular, if the supply of voucher cards is exhausted, the, retailer must typically order additional cards. Thus, the retailer may realize a loss of voucher card sales while waiting for the additional cards to arrive.

Yet another concern with voucher cards is that voucher card inventory reporting and management systems for retailers and operators, where such reporting and management systems exist, are typically inadequate. As a result, many retailers and operators do not have accurate or complete information as to the type and number of voucher cards in their respective inventories. Further, the lack of such information impairs the ability of the retailer, in particular, to adequately fulfill the demand for voucher cards. Moreover, inaccurate and/or incomplete inventory information may prevent a retailer from realizing that voucher cards have been stolen or misplaced.

As a result of these, and other, problems with voucher cards and related systems, many retailers, agents and operators are converting from voucher card systems to electronic replenishment systems such as electronic point-of-sale activation (“POSA”) replenishment. In general, such POSA replenishment systems communicate over standard phone lines and deliver inventory electronically on demand. While POSA replenishment systems represent an improvement of voucher card systems, typical POSA replenishment systems nonetheless suffer from a variety of inadequacies.

By way of example, typical POSA replenishment systems are limited to a specific product or operator, and are not configured to be modified to accommodate additional products or operators. Thus, a retailer desiring to sell a variety of prepaid services may be required to deploy a number of different POSA systems in order to support the desired product mix. Such multiple POSA system arrangements can be technically complex, and increase the overall costs realized by the retailer in conjunction with the sale of prepaid services.

A related problem is that many POSA replenishment systems are not configured to be employed in extended-point-of-sale (“EPOS”) environments. In particular, because such POSA replenishment systems are typically configured to interact with only a single cash register, they are not well suited for use in EPOS environments, such as supermarkets or other large stores, that include multiple cash registers. Consequently, some retailers are compelled to limit the number of POSA replenishment systems placed in the EPOS environment, thereby limiting sales flexibility and hindering sales of prepaid services. Alternatively, retailers may decide to employ a POSA replenishment systems for many, or all, cash registers in the EPOS environment. As noted earlier however, multiple POSA system arrangements are technically complex, and may also increase the overall costs realized by the retailer in conjunction with the sale of prepaid services.

In addition to the foregoing problems, many POSA replenishment systems are not configured to support generation, dissemination and printing of customized transaction and activity reports. Thus, retailers and operators typically do not have ready access to timely information concerning transactions that have been implemented by way of the POSA replenishment system. The lack of such information is a concern because, among other things, it impairs the ability of both the retailer and operator to evaluate potential demand for new products. Moreover, lack of access to timely transaction information may also compromise the ability of the retailer to perform analyses of sales volume and revenue such as may be required to develop budgets and other planning materials.

Yet other problems regarding POSA systems relate to aspects of the typical POSA hardware and software employed at the retailer site. With respect to POSA hardware for example, the display screens typically employed by POSA terminals are relatively small and difficult to read. Such terminals are often difficult for employees and customers to use. Further, many POSA terminals are limited to one, or only a few, methods by which information can be input, and are generally constrained to support only a single platform type, whether such platform is personal identification number (“PIN”)-based or PIN-less.

Typical POSA system software is problematic as well. For example, such POSA system software lacks flexibility in that it is generally limited to executing aspects of the requested transaction and displaying information that is concerned only with that specific transaction. Moreover, such POSA system software typically provides little or no functionality in terms of employee product education and training. This is a significant shortcoming in view of the high rate of employee turnover that is typically experienced in retail environments.

In view of the foregoing problems, and other problems in the art not specifically enumerated herein, what is needed are POSA systems, methods and software that facilitate effective management of prepaid services transactions. For example, such POSA systems, methods and software should permit the sale of multiple prepaid products through a single terminal and should be compatible with single cash register environments as well as EPOS environments. Further, the POSA systems, methods and software should be configured to operate in real time and just-in-time modes, as well as generate comprehensive reports concerning transaction activities. Finally, provision should be made for facilitating comprehensive, interactive training by way of the POSA terminal.

### BRIEF SUMMARY OF AN EXEMPLARY EMBODIMENT OF THE INVENTION

In general, embodiments of the invention are directed to systems, devices, methods, and software for use in implementing point-of-sale prepaid service transactions in the context of a client-server environment.

In one exemplary embodiment, a terminal is provided that is located at the point of sale and configured to implement various aspects of a prepaid service transaction. Generally, the terminal can be configured to operate in connection with both single cash register environments and EPOS environments. The terminal includes a power input configured to permit switchable operation between AC and DC current sources, in both domestic and foreign locations. A keyboard is also included that includes number keys, directional keys to aid in navigation of menu options, and various predefined function keys, as well as a ‘print/enter’ key and a ‘cancel’ key. This exemplary implementation of the terminal further includes a ‘magswipe,’ card reader input device.

Various communication functionalities of the terminal are implemented by way of a telephone line connection 408, exemplarily embodied as an RJ-11 2/6 connection, and/or a wireless communication device. The terminal also includes one or more external ports suitable for use in connecting various accessories, such as a bar code scanner. Other communication features of the exemplary implementation of the terminal include an internal modem. These, and/or other, communication elements permit use of the terminal in connection with a variety of different communication types and modes including, but not limited to, wireless communication, hardwire communications, and batch-type, real time, and JIT communication methodologies.

This exemplary implementation further includes an on-board thermal printer for printing prepaid service cards and reports. The memory functionality of the terminal is implemented by way of a flash memory that includes a protected boot sector so as to allow for software upgrades, as well as suitable RAM for implementing the terminal functionality.

Finally, the terminal includes two different displays. An interface display is provided on the front of the terminal and permits users such as clerks and managers to interact with the terminal for purposes such as training, obtaining reports, and implementing prepaid service product transactions. Mounted on the back of the terminal is a media display 417, oriented and positioned in such a way as to be readily perceived by consumers or prospective consumers.

The relatively large size of the media display, as well as its physical location and orientation, promotes ready perception and recognition by consumers and allows a wide variety of messages and information to be displayed. Exemplarily, the media display is programmable by the merchant and/or at the data center so that displays can be readily customized to suit a particular merchant, product, location, or other variable. Among other things, the media display permits dynamic message sizing, and also permits such display manipulations as scrolling, flashing, and top-to-bottom movement.

In operation, the merchant or other user employs the terminal to implement various prepaid service transactions and employee training procedures. Simultaneously, the media display presents consumers and prospective consumers with a dynamic mix of products and services, displayed in a fashion calculated to generate a desired response on the part of the consumer, that may be obtained by way of the terminal.

These and other aspects of embodiments of the present invention will become more fully apparent from the following description and appended claims.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 is a schematic diagram that illustrates various aspects of participants and relationships such as may be implicated by exemplary embodiments of the invention;

FIG. 1A indicates various exemplary products such as may be provided by way of the terminal;

FIG. 1B indicates various exemplary services such as may be provided, or implemented, by way of the data center;

FIG. 2 is a schematic diagram illustrating an exemplary hardware configuration of a value added services network configured to provide products and services to domestic locations;

FIG. 3 is a schematic diagram illustrating an exemplary hardware configuration of a value added services network configured to provide products and services to domestic and/or foreign locations;

FIGS. 4A through 4C illustrate various aspects of an exemplary embodiment of a terminal;

FIG. 5 illustrates various aspects of an exemplary data packet such as may be used in connection with various communications protocols;

FIG. 6 is a flow diagram illustrating aspects of an exemplary process for implementing a real-time transaction or related process using a real time communication methodology;

FIG. 7 is a flow diagram illustrating aspects of an exemplary process for implementing a just-in-time transaction or related process using a just-in-time communication methodology;

FIG. 8 is a schematic diagram illustrating aspects of an exemplary batch mode communication methodology;

FIG. 9 is a flow diagram illustrating aspects of an exemplary transaction process that can be executed by a consumer or merchant;

FIG. 10 is a flow diagram illustrating aspects of an exemplary home dial tone transaction process;

FIGS. 11A and 11B comprise a flow diagram illustrating aspects of an exemplary unique denomination magswipe transaction process;

FIGS. 12A through 12C comprise a flow diagram illustrating aspects of exemplary transactions concerning wireless phone services and related products;

FIG. 13 is a flow diagram illustrating aspects of an exemplary process for creating and printing a prepaid services card;

FIG. 14A is a flow diagram illustrating aspects of an exemplary report selection and reporting process;

FIG. 14B is a flow diagram illustrating aspects of an exemplary interaction between the terminal and the data center in the event of a report request by the terminal;

FIG. 15 is a flow diagram illustrating aspects of an exemplary process whereby a user such as a clerk or manager requests a report using the terminal;

FIG. 16 is a flow diagram illustrating aspects of an exemplary training procedure such as may be implemented by way of the terminal; and

FIG. 17 is a schematic diagram that illustrates aspects of exemplary training instructions as may be employed in connection with various training procedures.

### DETAILED DESCRIPTION OF SELECTED EMBODIMENTS OF THE INVENTION

Reference will now be made to the drawings to describe various exemplary embodiments of the invention. It is to be understood that the drawings are diagrammatic and schematic representations of such exemplary embodiments, and are not limiting of the scope of the present invention in any way, nor are they necessarily drawn to scale.

The present invention relates generally to prepaid services. More particularly, embodiments of the present invention relate to systems, methods, and software for use in the implementation and management of prepaid services transactions. As described below, embodiments of the invention permit the sale of multiple prepaid products through terminals located at multiple merchant locations. Such terminals are compatible with a variety of environments, including single cash register environments as well as EPOS environments. Moreover, the terminals are configured to provide comprehensive and interactive employee and manager training at the merchant site, and the terminals also generate various customized reports for use by the merchant and others. Additionally, embodiments of the invention provide for a variety of communications modes such as real time, batch, and just-in-time.

Thus, embodiments of the invention provide for, among other things, centralized, integrated and consistent implementation of the sale and/or resale of a variety of prepaid services at multiple merchants, thereby permitting one or several operators to reach a large number of customers easily and efficiently. Moreover, the relatively low expenses associated with implementation of such sales results in attractive sales margins for merchants, brokers and operators. Further, comprehensive transaction data is consistently and reliably distributed to various participants

I. General Aspects of Exemplary Transactional Relationships

The following general discussion is directed to various exemplary relationships between the various entities or participants in association with which the functionality disclosed herein may be implemented. Such discussion further addresses general aspects of some exemplary operating environments for embodiments of the invention. In conjunction with the discussion of such exemplary operating environments, various operational aspects of embodiments of the invention are considered. However, a more detailed description of such operational aspects, and others, of embodiments of the invention is provided following the aforementioned general discussion.

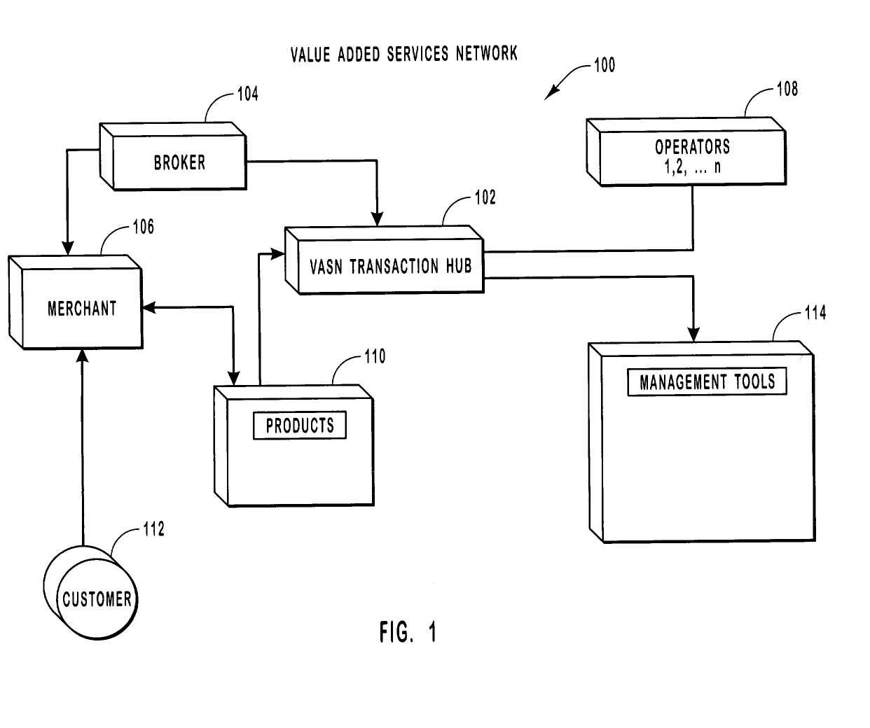

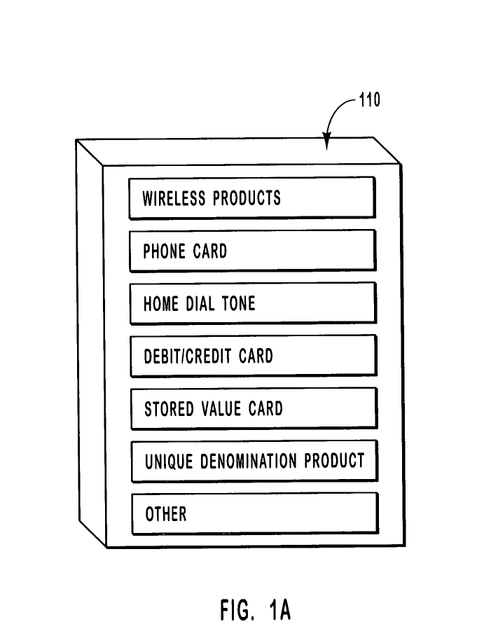

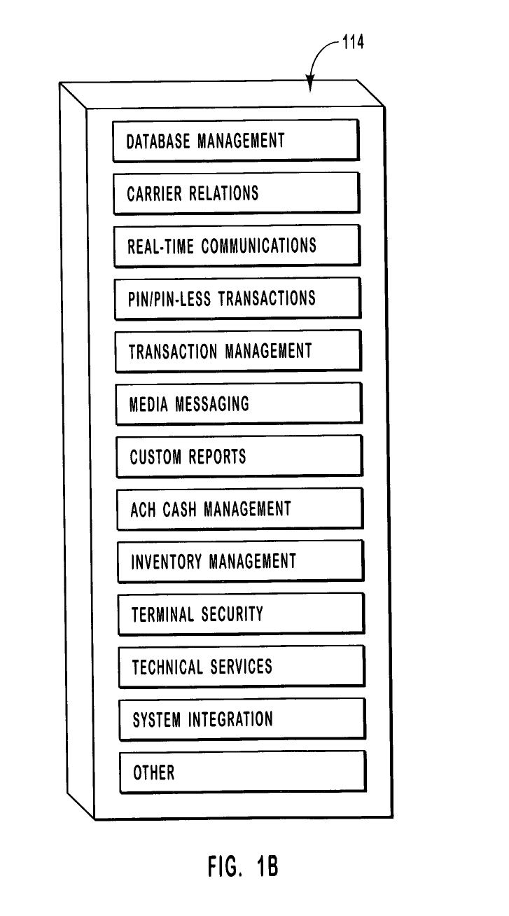

Directing attention now to FIG. 1, details are provided concerning various aspects of exemplary participants, and associated relationships, such as may be implicated by embodiments of the invention. By way of example, at least some embodiments of the invention may be implemented in the form of a value added services network (“VASN”), denoted generally at 100 in FIG. 1. In the illustrated exemplary embodiment, the VASN 100 includes a VASN transaction hub 102 configured to communicate, either directly or indirectly, with a broker 104 and merchant 106, as well as various operators 108, in order to coordinate, manage and implement the provision of products and services 110 to various customers 112 through the merchant 106.

In connection with the foregoing, it should be noted that a wide variety of products and services 110 may be provided through arrangements such as those exemplified by the VASN 100. It is sufficient to note at this juncture that such products and services 110 may generally comprise any product or service that can be sold through some type of prepaid arrangement. Further details concerning exemplary products and services 110 such as may be provided in conjunction with arrangements such as VASN 100 are provided below in connection with the discussion of FIG. 1A, and elsewhere herein.

With continuing attention now to the exemplary embodiment of the VASN 100, it should be noted that the illustrated combination of entities that comprise some or all of the VASN 100 is exemplary only and various additional, or alternative, types and numbers of entities may be included within the scope of the VASN 100. For example, in some exemplary implementations, the broker 104 comprises a telecommunications or ‘telecom’ broker. However, various other types of brokers may participate in the VASN 100 consistent with, for example, the particular products and services 110 that are intended to be supplied to the merchant 106. Similarly, the operators 108 generally comprise any operator, or carrier, that desires to provide products and/or services to the customers 112 through the merchant 106. Such operators may include, for example, wireless phone service companies, home dial tone providers, and financial institutions.

Moreover, aspects of the functionality disclosed herein are desirable for use by a wide variety of sizes and types of merchants 106. Such merchants may be small specialty stores that sell just a few products or services, or may alternatively comprise large corporations with multiple stores that sell hundreds or thousands of different products and services. Thus, exemplary merchants 106 include, among others, franchise convenience stores, grocery stores, specialty stores, neighborhood stores, warehouse-type stores, and the so-called ‘big box’ retailers. More generally however, aspects of the functionality disclosed herein would prove useful to any merchant 106 desiring to sell one or more of the products and services 110 to customers 112, or others.

As further indicated in FIG. 1, the VASN transaction hub 102 of the VASN 100 is configured to implement, provide, and/or otherwise facilitate, various management services and information management tools, collectively ‘management tools’ 114 to assist VASN 100 entities such as merchants, brokers and operators. Generally, such management tools 114 are concerned with the effectuation of prepaid services transactions, and related processes. Further details regarding exemplary management tools 114 are provided below in connection with the discussion of FIG. 1B.

Directing attention now to FIG. 1A, further details are provided concerning exemplary products and services 110 such as may be provided to customers 112. In particular, any of a wide variety of products and services 110 may be provided to the merchant 106, and ultimately to the customer 112, in conjunction with the implementation of embodiments of the invention. In at least some embodiments of the invention, one or more of such products 112 comprise various types of prepaid products and services such as, but not limited to, wireless phone air time, long distance air time, Internet access, Internet cash, Internet data service, gasoline, car washes, telephone calling cards, home dial tone service, or any other product or service that can be sold on a prepaid basis, as well as debt and credit cards, unique denomination cards, or any of a variety of other types of stored value cards.

Moreover, and as discussed in further detail elsewhere herein, products and services provided in connection with embodiments of the invention may be configured and customized in any of a variety of ways as necessary to suit considerations such as, but not limited to, the requirements of a particular application, product, service, operating environment, merchant, or customer. Accordingly, the products and services 110 disclosed herein are exemplary only and should not be construed to limit the scope of the invention in any way.

With attention now to FIG. 1B, details are provided concerning exemplary management tools 114 such as may be usefully implemented in connection with the operation of VASN 100 and its components. In particular, the VASN transaction hub 102 implements, includes, and/or otherwise embodies, various information management services and management tools to assist participants such as merchants, brokers and operators in connection with the sale and/or resale of various products and services 110, and other products and services, with which embodiments of the VASN 100 and related components are concerned. Further, such management tools 114 may take various forms, and one or more management tools 114 can be provided in various combinations or packages to the merchants, brokers and/or operators, or others.

As more particularly indicated in FIG. 1B, exemplary management tools, 114 include management of databases such as product and transaction databases, as well as management of sales transactions effected by the merchant, automated clearing house (“ACH”) cash management, and merchant and operator inventory management. Additional examples of the management services provided by the VASN transaction hub 102 relate to relations between the merchant 106 and various carriers or operators 108. Further, the VASN transaction hub 102 may provide for real-time communications concerning various processes performed in connection with embodiments of the invention. Moreover, at least some implementations of the VASN transaction hub 102 provided for personal identification number (“PIN”) or PIN-less transactions relating to the sale and/or resale of products and services 110. In general, a PIN is required in order to use a printed prepaid services card, unless the particular system employed is a PIN-less system. In at least some implementations of PIN-based systems, the PINs comprise the actual inventory that is stored at the terminal.

In addition, some implementations of the VASN transaction hub 102 provide for media messaging, at the merchant location for example, and are also configured to generate various types of reports, for a variety of different end users, concerning products and services 110 and associated transactions and processes. Yet other exemplary management tools 114 include terminal security services, technical services and system integration services such as might be required to implement and/or streamline operations between, for example, the VASN 100 and various merchant computer and data processing systems such as an EPOS system. Various additional, or alternative, management tools 114 may be provided consistent with particular products and transactions, and other requirements and variables.

As suggested by the foregoing brief enumeration of exemplary management tools 114, there is a wide variety of management tools 114 that may be provided in conjunction with the implementation of embodiments of the invention. In general, such management tools 114 may relate to any aspect of the various products and services 110 that are provided to the merchant 106 and/or the customer 112, and/or to any related processes. Accordingly, the foregoing enumeration of exemplary management tools 114 should not be construed to limit the scope of the invention in any way.

II. General Aspects of Exemplary Operating Environments

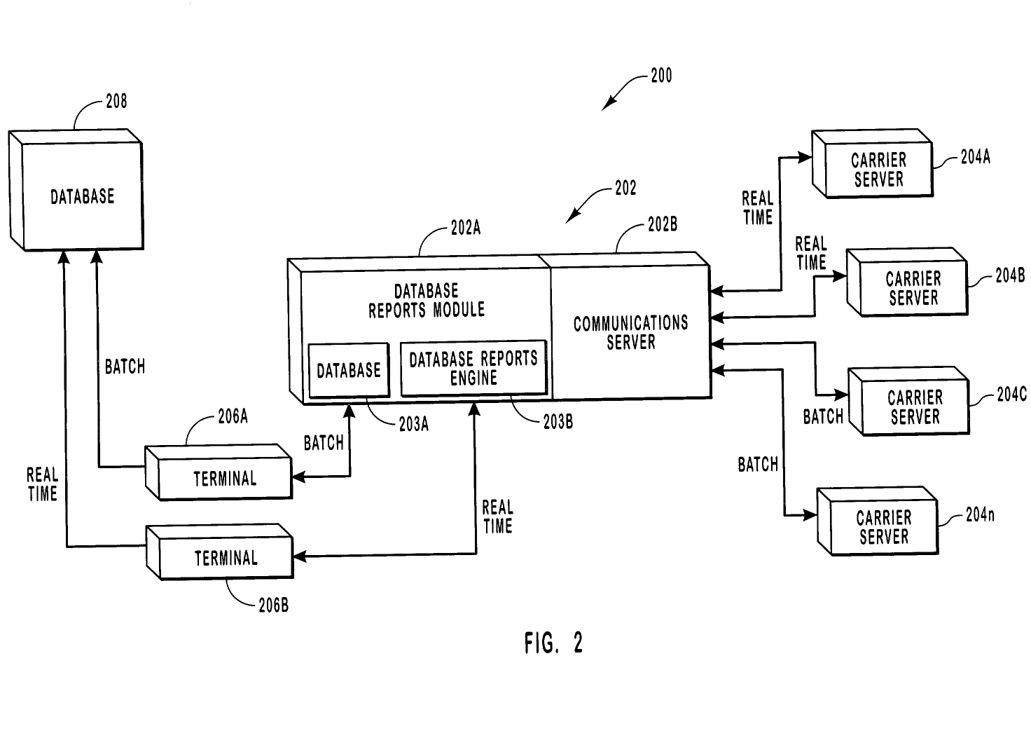

Directing attention now to FIG. 2, and with continuing attention to FIGS. 1 through 1B, details are provided concerning various aspects of an exemplary VASN operating environment 200 for implementing some or all of the functionality disclosed herein with respect to aspects of the VASN 100 and its components. Note that exemplary embodiments of the VASN operating environment 200 may comprise both hardware and software.

In the illustrated embodiment of the VASN operating environment 200, a data center 202 is provided that is configured to communicate with one or more carrier servers 204A, 204B, 204C and 204n. In some implementations, multiple data centers 202 are provided. The illustrated exemplary embodiment of the data center 202 includes a database reports module 202A having a database 203A and associated database reports engine 203B that generally serves to generate, in accordance with various criteria, reports concerning data contained in the database. Further, the data center 202 exemplarily includes various prepaid services product inventories and associated PIN numbers that are supplied to consumers as part of a prepaid service product transaction initiated at one or more terminals, discussed below.

With continuing reference to aspects of the exemplary data center 202, a communications server 202B is also provided through which communications are transmitted from, and received by, the data center 202. The illustrated configuration of the data center 202 is exemplary only however, and various other configurations may be employed consistent with the requirements of a particular application and/or operating environment.

Generally, the data center 202 communicates with one or more of the carrier servers 204 concerning various products to be made available by way of terminals 206A and 206B which reside at the merchant location and are configured to communicate with, among other things, the data center 202. Note that ‘carrier servers’ refer to the servers associated with various service providers, carriers or operators, also referred to herein as ‘operator service carrier,’ such as, but not limited to, mobile phone service carriers and any other entity that provides, or makes available, one or more products and services to the customer 112 by way of the merchant 106.

As discussed in further detail below, communication between the components of the VASN operating environment 200, such as the carrier servers and the data center 202 for example, may be implemented in various ways. For example, some carrier servers 204 are configured to communicate with the data center 202 in a batch mode. In other cases, one or more of the carrier servers 204 communicate with the data center 202 in a real time mode. The same is likewise true with respect to communications between terminals 206A and 206B and the data center 202. That is, such communications may be implemented in batch, real time, or other modes, such as a just-in-time (“JIT”) communications mode. More generally however, the various communications implicated by the VASN operating environment 200 may be implemented in any way or mode suitable for the intended application and/or operating environment.

With continuing reference to FIG. 2, the terminals 206A and 206B are further configured to communicate with a database 208 that, in turn, is configured for communication with the data center 202. In at least some implementations, the database resides at a remote host. In still other cases, the database 208 is associated with a broker in conjunction with whom various products and services are supplied to the merchant and, ultimately, to the consumer or customer. In yet other implementations however, there is no broker relationship and, instead, the database or databases are associated with each of the carrier servers. Exemplarily, the database 208 receives transaction information from one or more of the terminals 206A and 206B. In some of such implementations, a backup copy of such transaction data is also provided to the data center 202.

In general, communications between the terminals 206A and 206B and the database 208 may, similar to other communications implemented with respect to the VASN operating environment 200, take a variety of forms including, but not limited to, batch communications, real-time communications, and JIT communications. Further details concerning various exemplary aspects of communications between components of the VASN operating environment 200 are provided elsewhere herein.

As suggested by the foregoing discussion, the exemplary configurations illustrated in FIGS. 1 through 2A implicate various useful functionalities concerning the various prepaid services product inventories and associated PIN numbers that, exemplarily, are centrally located at the data center 202 and that are supplied to consumers in connection with prepaid service transactions initiated at one or more of the terminals. Further details will now be provided concerning such materials.

Exemplarily, both the product inventories and PIN numbers are supplied to the data center 202 by one or more carriers or operators 108. In addition, the data center 202 may include various marketing and promotional materials, also supplied by one or more carriers or operators 108, that are distributed to one or more terminals in accordance with various predefined criteria such as, but not limited to, the product mix associated with that terminal, the type of merchant with whom the terminal is associated, the geographical location of the terminal, the desires of the merchant, and sales trends at that terminal.

Thus, one aspect of the data center 202 is that various combinations of products, PINs and promotional materials can be simultaneously dispensed from the data center 202 to multiple terminals, domestic and/or international locations. Because the mix of products and promotional materials can be predefined, the group of products and promotional materials available at any given terminal can be readily customized, consistent with various requirements and identified needs.

Moreover, the centralization of products and promotional materials at the data center 202 permits ready and simultaneous implementation of changes to the product mix, as well as the mix of promotional or other materials that may be available at a given terminal or group of terminals. Such an arrangement is useful to carriers, for example, as they can readily make products and marketing materials available to a large pool of potential consumers. Moreover, participants such as brokers, merchants and operators can quickly and easily change the mix of materials available at a particular terminal or group of terminals. Such aspects of embodiments of the invention are useful where, for example, an operator desires to test market a new product, or quickly make a new product widely available.

The centralization of various functions and data at the data center is useful for other reasons as well. For example, at least some implementations of the invention provide for transmission of real-time feedback to one or multiple carriers concerning aspects of prepaid service transactions such, but not limited to, the type and volume of sales associated with a particular terminal or group of terminals.

It should be noted here that embodiments of the invention are not limited solely to arrangements where products, PINs and other materials are located at the data center. In at least some embodiments of the invention, products and PINs, as well as other materials, are located at the terminal. As discussed below, such an arrangement has useful implications in situations where, for example, a real-time communications mode is desired to be employed.

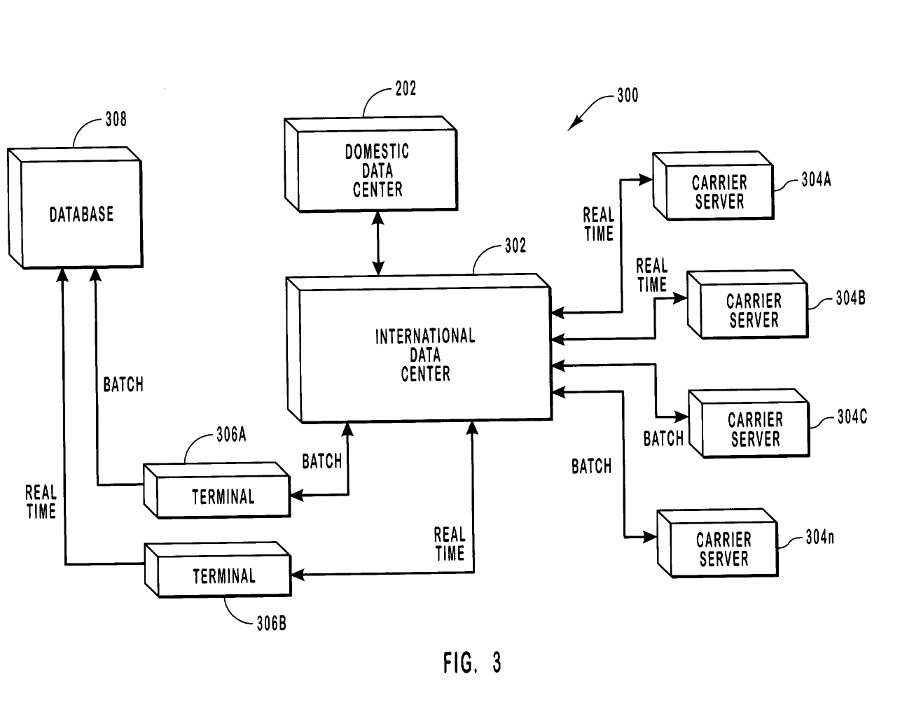

Directing attention now to FIG. 3, an alternative implementation of a VASN operating environment, generally denoted at 300, is illustrated. In terms of both its structure and operation, the VASN operating environment 300 is similar in many regards to the VASN operating environment 200. One exception however, is the presence of the international data center 302. The international data center 302 generally functions in a manner similar to the data center 202 and is configured for communication with, among other things, various carrier servers 304A, 304B, 304C and 304n, as well as one or more terminals 306A and 306B, and a database 308.

In addition, the international data center 302 is also configured to communicate with a domestic data center 304, exemplarily located in the ‘home’ country of the VASN transaction hub 102 (see FIG. 1). The domestic data center 304 may be connected to multiple other international data centers, as well as its own associated carrier servers, terminals, and databases. Arrangements such as those illustrated in FIG. 3 afford, among other things, comprehensive management of prepaid services transactions, and related processes, in both domestic and international locations, thereby providing useful services to a wide variety of merchants and permitting carriers and other vendors to reach an international pool of consumers. Moreover, the implementation of such functionality is further advanced by the capability of embodiments of the invention to implement transactions using a wide range of currency types.

As indicated by the foregoing discussion, as well as the other disclosure herein, concerning the various relationships and operating environments associated with exemplary embodiments of the invention, such embodiments provide for a variety of useful functionalities. In this regard, it should be noted that the various distributions, disclosed herein, of the functionalities among the various components of the VASN and associated hardware configuration are exemplary only. More generally, these and other functionalities disclosed herein may be distributed and/or implemented in any other suitable way as well.

At least some useful aspects of embodiments of the invention concern the interaction between the data center and the terminals and carriers. For example, the data center, in combination with one or more terminals, is effective in implementing the initiation, processing, and printing of various transactions and related on-demand reports concerning any of a variety of prepaid services provided by various carriers to merchants, in both domestic and international locations. Thus, embodiments of the invention provide for, among other things, the promotion, sale, and the collection of money, as well as multi-level distribution channel reporting. Further, the data center also provides a wide variety of management services to one or more of the entities in, or associated with, the VASN. Among other things, such management services further advance the implementation and management of various prepaid services transactions.

Further, the various communication modes that may be employed by embodiments of the invention further contributes to the flexibility of the VASN and permit, among other things, dynamic, real-time reporting of transactional data, and related data, at the terminal and other locations in the VASN, thereby allowing the merchant and others to perform various trend analyses, as well as develop budgets and other planning materials. Additionally, the terminal cooperates with the data center to provide user-friendly interactive training at the merchant location. Further, the physical configuration of the terminal is well-suited to present customers with a dynamic variety of media display messages such as may be desired to be sent by brokers, merchants, carriers or other paid advertisers.

Yet other aspects of embodiments of the invention are considered elsewhere herein in connection with the discussion of various exemplary operations performed in association with such embodiments. Many of such exemplary operations are initiated by way of the terminal. In view of the foregoing, attention is directed now to a discussion of various aspects of some exemplary embodiments of a terminal such as may be employed in the VASN operating environment 200, or other suitable operating environments.

III. General Aspects of an Exemplary Embodiment of the Terminal

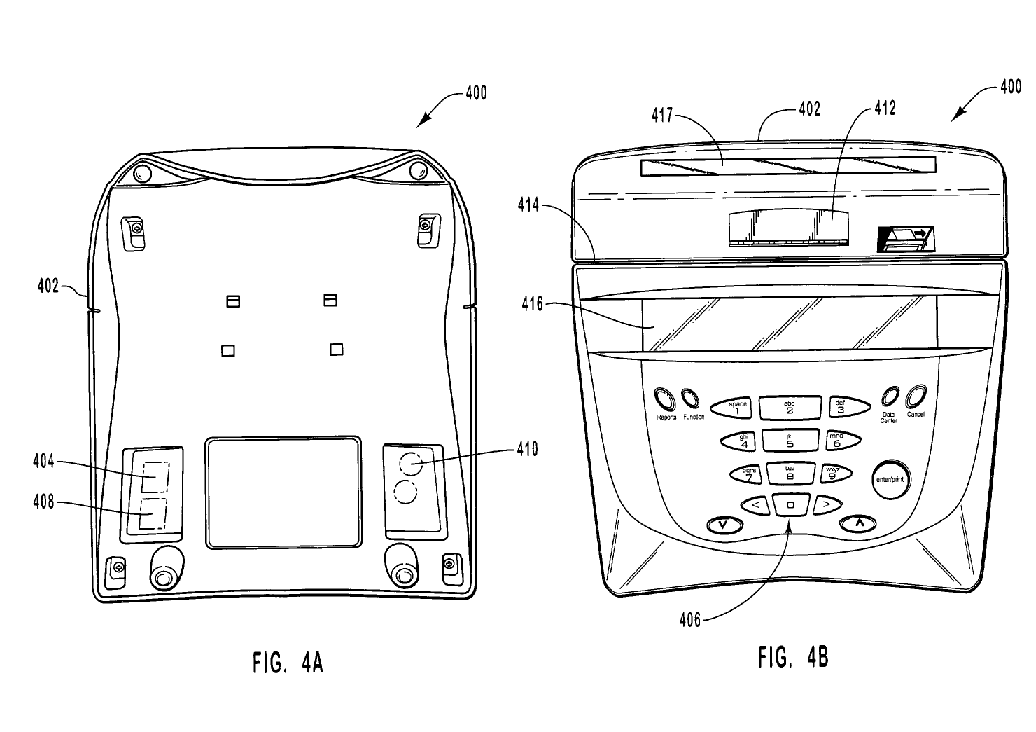

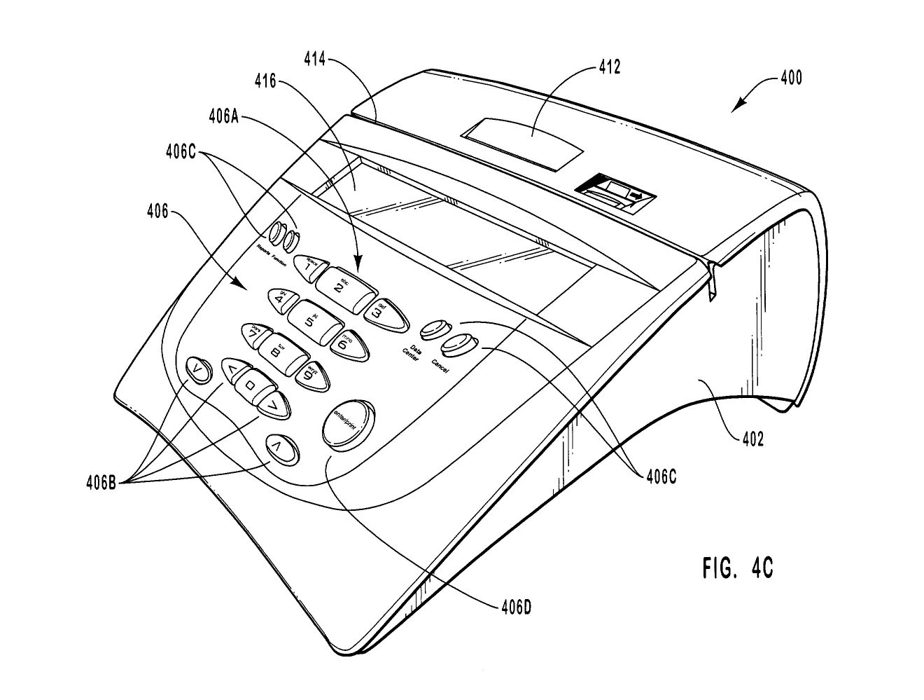

With attention now to FIGS. 4A through 4C, details are provided concerning various aspects of an exemplary embodiment of a terminal (see, e.g., FIGS. 2 and 3), denoted generally at 400, by way of which various prepaid products may be marketed, promoted, and/or sold. In general, the terminal 400 includes various circuitry and components suitable for implementing the functionality disclosed herein, and substantially enclosed within a housing 402. Exemplarily, the terminal 400 may be configured for use in conjunction with a single cash register, or similar device, or multiple cash registers, as in an EPOS environment, or may alternatively be configured for use in various other types of merchant environments.

The illustrated embodiment of the terminal 400 includes a power input 404 configured to permit switchable operation between, for example, 120 volts alternating current (“VAC”) and 24 volts direct current (“VDC”). The VAC and VDC parameters may be changed as necessary to permit use of the terminal 400 with foreign country power supplies. At least some embodiments of the terminal 400 also include an international power source (not shown), which may be specific to a particular country or group of countries.

The illustrated embodiment of the terminal 400 further includes a keyboard 406 that exemplarily includes the ‘0’ through ‘9’ number keys, collectively denoted at 406A, as well as four directional keys 406B that permit a user, such as a merchant, consumer, or trainee, to navigate through various menu items and displays. In addition, four function keys 406C are provided that generally permit a user to initialize particular functions that correspond with each of such keys. Such functions may comprise one or more user-defined and/or preprogrammed functions. The keyboard 406 further includes a ‘print/enter’ key 406D. Further, the configuration and arrangement of keyboard 406 may be configured as necessary to permit use of the terminal 400 in conjunction with foreign languages and/or foreign currencies. Various additional, or alternative, keys may likewise be implemented within embodiments of the terminal 400. By way of example, one alternative embodiment of the keyboard 406 is configured to include two, instead of four, directional keys. This embodiment further comprises three function keys. Instead of a fourth function key, a ‘CANCEL’ key is provided. Thus, the illustrated arrangement and combination of terminal keys is exemplary only and should not be construed to limit the scope of the invention in any way.

In addition to the keyboard 406, the illustrated embodiment of the terminal 400 includes at least one other input device as well. In particular, a magnetic swipe, or ‘magswipe,’ card reader 414 is provided. Among other things, the magswipe card reader 414 permits the use of debit and credit cards to purchase various prepaid services offered by way of the terminal 400. In addition to its data input functionality, the magswipe card reader 414 also permits replenishment of prepaid services cards. In yet other exemplary embodiments of the terminal 400, a barcode reader (not shown) is provided.

Consistent with structure such as the magswipe card reader 414 and keyboard 406, exemplary embodiments of the terminal 400 permit, or are otherwise compatible with, a variety of data entry types. For example, such embodiments permit the entry of undefined or unique card denominations, as compared with card denominations of predetermined incremental size, as well as the entry of unique data such as account numbers.

The terminal 400 is also configured to accommodate various communication hardware options. For example, the illustrated embodiment of the terminal 400 includes a telephone line connection 408, exemplarily embodied as an RJ-11 2/6 connection, as well as one or more RS 232 external ports 410 suitable for use in connecting various accessories such as, but not limited to, a magnetic strip scanner or bar code scanner. Various other connections, ports and accessories may likewise be employed.

Additional communication features of the terminal 400 include an internal modem (not shown) in communication with the telephone line connection 408 and the RS 232 external port 410. Exemplarily, the internal modem is programmable for multiple destinations and has sufficient bandwidth to allow selected data transfers to/from the terminal 400 to be effected in about a minute or less. In some implementations, the internal modem is Federal Communications Commission (“FCC”) part 68 certified and comprises a plug-in module mounted to the main printed circuit board (not shown) in the terminal 400. Exemplarily, the modem includes both line and phone connectors. As suggested earlier, the terminal 400 is compatible with a variety of different communication types and modes including, but not limited to, wireless communication, batch-type two-way communication, real time communication, and JIT communication, which may be implemented on transactional or product bases, among others.

Yet another feature included in the illustrated embodiment of the terminal 400 is an on-board thermal printer 412 which permits ready hardcopy capture of various reports and other information generated at, and/or accessible by way of, the terminal 400. The thermal printer 412 also permits generation and delivery of new and replenished prepaid service cards. In at least one exemplary embodiment, the thermal printer 412 has an associated total cycle time of about five (5) seconds. One exemplary implementation of such a thermal printer 412 is an Axiohm CMDG-0014 having a 200 DPI thermal print head.

Among other things, the capabilities implemented by the thermal printer, or other suitable printing device, eliminate the need for a merchant to keep an inventory of prepaid service cards. Elimination of such inventory, in turn, virtually eliminates the loss of cards due to theft, and also relieves the merchant of the burden of tracking such inventory.

Other aspects of exemplary embodiments of the terminal 400, but not illustrated in FIGS. 4A through 4C, concern the terminal memory. In particular, at least some embodiments of the terminal 400 include a flash memory that includes a protected boot sector so as to allow for software upgrades. The terminal memory further includes suitable RAM for implementing the functionality disclosed herein.

Exemplarily, the terminal 400 is configured to store up to a total of twenty (20) passwords, comprising any combination of different types of users, such as clerks and managers. In addition, at least some exemplary embodiments of the terminal 400 are programmed to lock up, and thereby limit or prevent user access to specified functionality, in the event a password is entered three times incorrectly. In such cases, only the ‘call data center’ functionality will remain operational so that authorized personnel can contact the data center and request unlocking of the terminal.

In one implementation of the terminal 400, the prepaid service cards generated by the thermal printer 412 are coated to permit direct thermal printing and measure about 0.010 millimeters thick, and are about 2⅛ inches wide by about 3⅜ inches long with corners having a radius of about 0.125 inches. In at least some embodiments, the card comprises cut stock. Such prepaid service card geometries and materials are exemplary only however, and various other card sizes, materials and configurations may alternatively be employed.

With continuing reference now to FIGS. 4A through 4C, the illustrated embodiment of the terminal 400 further includes an interface display 416 positioned on the front of the: terminal 400 so as to be oriented toward the merchant, clerk, or other user. Generally, the interface display 416 permits such users to interact with the terminal for purposes such as training, obtaining reports, and implementing prepaid service product transactions. In one exemplary implementation, the interface display 416 comprises a United Radiant Technology Corp., model UMS-3071AN-G, having a 4 line×40 character ASCII LCD without backlight. Typical power requirements for such an interface display 416 are 1.2 ma at 5V. The interface of this exemplary interface display 416 is 8 bit parallel.

Mounted on the back of the terminal 400 is a media display 417, oriented and positioned in such a way as to be readily perceived by consumers or prospective consumers. In at least some implementations, the media display 417 comprises four (4) rows of forty (40) characters each, configured in a fluorescent vacuum display (“FVD”). Alternatively, the media display 417 may comprise a 4×40 liquid crystal diode (“LCD”) display. The relatively large size of the media display 417 promotes ready recognition by consumers and allows a wide variety of messages and information to be displayed.

Moreover, the media display 417 is programmable by the merchant and/or at the data center so that displays can be readily customized to suit a particular merchant, product, location, or other variable. Among other things, the media display 417 permits dynamic message sizing, up to 256 characters per message in some implementations, and also permits such display manipulations as scrolling, flashing, and top-to-bottom movement.

As suggested by the foregoing, and discussed in further detail elsewhere herein, embodiments of the terminal 400 have various aspects that are useful in a wide variety of applications. For example, embodiments of the terminal 400 are configured to provide multiple products, that may have multiple associated denominations, from multiple carriers. Such hierarchical flexibility permits a high level of customization in terms of the type and mix of products that can be provided through a given terminal 400. Moreover, the transactions associated with such products may be PIN-based or non PIN-based (“PINless”), and/or may incorporate transaction management based on a specific limit identified for a given transaction, or type of transaction.

As another example of such useful aspects, embodiments of the terminal 400 include software that is configured to permit different access levels to the terminal functionality, based upon, for example, the status of the user. For example, the terminal 400 can be configured and/or programmed so that a manager would have access to a broader range of features than would a clerk. Additionally, the terminal 400 may be programmed to produce a wide variety of user-defined, or default, transaction reports based upon variables including, but not limited to, the user identification, terminal location, product type, product provider, and predefined timeframe. Such reports may be generated automatically according to a predetermined time schedule, or may be generated in response to the occurrence of a particular event. Alternatively, such reports may be generated on-demand.

Other programmable aspects of the terminal 400 concern advertising and point-of-sale marketing (“POSM”) materials. In particular, the terminal 400 software may be programmed to present, on the media display 417, various advertising and marketing materials provided by the data center, broker, merchant, carrier server, or other participant. The type, mix, and timing of such materials may vary according to the user, date, terminal location, terminal configuration/programming, products and services accessible through the terminal, and/or the particular merchant.

The programming of the terminal 400 to implement the exemplary functionalities disclosed herein may be implemented in various ways. For example, some programming may occur before the terminal is shipped to the end user. Other programming may occur at the time the terminal is set up for use at the merchant location. Still other programming can be implemented from remote locations, such as the data center for example, from time to time. Generally, aspects such as the timing, nature, scope and source of the terminal programming can be adjusted as necessary or desired.

Yet another aspect of exemplary embodiments of the terminal 400 is that the terminal is configured to cooperate with the data center (see, e.g., FIG. 2) to provide on-line interactive training for sales clerks and other personnel. This functionality is particularly useful in light of the relatively high level of turnover typically experienced with regard to convenience store clerks and similar personnel. Moreover, such training can be readily customized to suit a particular merchant and product mix, and/or other related variables, so that the trainee does not spend valuable time learning skills that will not be required in the performance of the duties associated with that merchant or product mix. Further, a particular training module can be readily updated in the event that the merchant decides to carry a new product.

In connection with the implementation of various transactions and processes concerning the terminal, and other components of the VASN operating environment 200, various communication processes and transmission protocols may be employed. Accordingly, attention is directed now to a discussion of various exemplary transmission protocols such as may be employed in connection with communications within and without the VASN operating environment 200.

IV. Aspects of Exemplary Transmission Protocols

In general, aspects of communications concerning the VASN 100 (see FIG. 1) and VASN operating environment 200 (see FIG. 2), and their respective components, may be implemented in various ways. For example, embodiments of the invention provide for the use of various transmission protocols to guide the formation and transmission of communications. In at least some implementations, the use of a particular transmission protocol may be governed by the particular transmitting and/or receiving device, and/or other variables. More generally however, any transmission protocol effective in implementing the functionality disclosed herein may be employed.

In one exemplary implementation, communications between the terminals and the data center are governed by a transmission protocol based on data stream communications, wherein the data carried such data streams is organized or configured in the form of one or more data packets. Depending upon variables such as the application and operating environment, for example, such data streams may be encrypted in some cases. Various types of data streams may be devised and implemented in accordance with particular requirements or a particular operating environment.

By way of example, a ‘server event’ data stream may specify, among other things, an action to be taken by a server associated with the VASN operating environment 200. As another example, a ‘cardback’ data stream, pertaining to the generation of a prepaid services card, may comprise a receipt for the generated card. The foregoing are exemplary only however, and any other type of data streams and/or data stream components effective in facilitating implementation of the functionality disclosed herein may alternatively be employed.

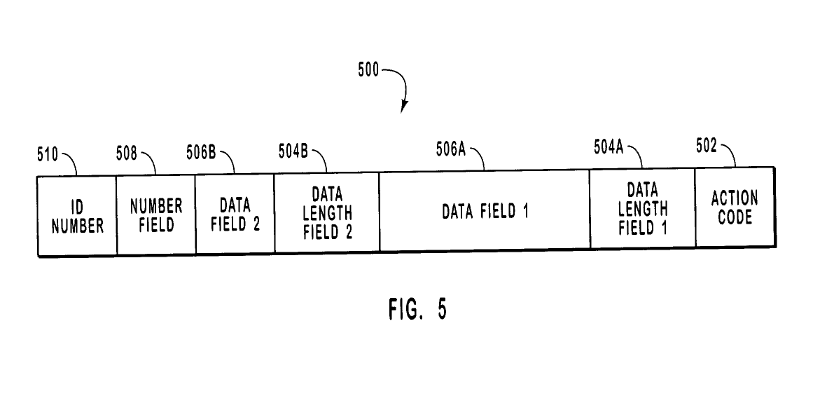

Directing attention now to FIG. 5, details are provided concerning aspects of an embodiment of a data packet such as may be employed in connection with some types of data streams and transmission protocols. In general, exemplary implementations of transmission protocols provide for a data stream that comprises a variety of data packets 500, each of which comprises various fields, examples of which include an action code field 502, data length fields 504A and 504B, data fields 506A and 506B, one or more number fields 508 and an identification (“ID”) number field 510. Various other data packet 500 configurations may alternatively be employed however, consistent with the requirements of a particular application or operating environment.

With respect to aspects of the individual fields of the data packet 500, the action code fields 504A and 504B exemplarily comprise single (1) byte fields that specify an action code that signifies the action to be taken, for example, by the recipient of the data stream with respect to the data contained in the data packet 500 and, more particularly, in the data fields 506A and 506B. The various action codes that may be specified in connection with implementation of the invention are virtually limitless. Exemplary action codes specify, among other things, how the data is to be handled by the recipient, and actions that must be implemented upon receipt of the data.

As indicated in the illustrated embodiment, one or more data length fields 504A and 504B follow the action code field 502 and serve to specify the number of 1-byte pieces of the data stream that comprise the corresponding data fields 506A and 506B, respectively. Such data fields 506A and 506B are sometimes collectively referred to as the ‘data payload’ or ‘payload’ of the data packet. Exemplarily, the data length fields 504A and 504B each comprise 2-byte fields. Similar to the action codes, the data length fields may be configured or defined to convey, either implicitly or explicitly, certain information concerning the data payload of data packet 500. If, for example, a data length field has a zero (‘0’) value, such value can signify that the corresponding data field has no value. As suggested above, a zero value data field may accordingly have implications with respect to the action or actions specified by the action code of the data packet.

With continuing reference to FIG. 5, the illustrated embodiment of the data packet 500 further comprises one or more identification (“ID”) number fields 510. Unlike the data fields 506A and 506B, such ID number fields 510 generally do not have an associated leading 2-byte data length field. In the exemplary case of a server event stream, such ID fields may contain, for example, an ID number corresponding to a particular product or denomination. The ID number fields may also contain information such as the user-specific access numbers required for access to a terminal.

Moreover, the specified ID number may be employed, in combination with other fields of the data packet 500, to specify certain actions. With respect to a server event stream for example, if the ID number field 510 for a particular object, such as a product or denomination, contains a value, but all other fields in the server event stream relating to that object are zero, such combination of values indicates that the specified object should be deleted. As another example, if a cardback data stream is transmitted whose ID number field 510 has a zero value, that value signifies that the cardback data stream comprises a cardback receipt for a real time transaction and should, accordingly, be printed.

As illustrated by the foregoing examples, the data packet 500 and, more generally, the data stream, can be configured in any of a variety of ways so as to convey information either implicitly or explicitly, and/or to cause the implementation of various actions. In view of the wide variety of possible combinations of fields, and implementations of the transmission protocol and associated data packet and data stream, and such examples are not intended, nor should they be construed, to limit the scope of the invention in any way.

In connection with the use of various transmission protocols such as those disclosed herein, a variety of different communication methodologies may be employed. Accordingly, consideration will now be given to a few of such communication methodologies.

V. Aspects of Exemplary Communication Methodologies

It has been noted elsewhere herein that, in addition to various transmission protocols, yet other aspects of communications associated with the VASN 100 (see FIG. 1) and VASN operating environment 200 (see FIG. 2), and their respective components, concern various communication modes employed by embodiments of the invention. Examples of such communication modes include, among others, a batch communication mode, a real time communication mode, and a JIT communication mode. In some exemplary embodiments, the particular communications mode employed is a function of variables such as, but not limited to, the particular transmitting and/or receiving devices, or devices, and the type of data to be transferred. Additional or alternative factors may likewise play a role in determining the communications mode to be employed in a particular situation.

Generally, communications methodologies such as those disclosed herein are not contemplated to be restricted for use with any particular combination of devices. Instead, one or more communication methodologies may be employed in any way consistent with the functionality disclosed herein. Accordingly, the exemplary uses of particular communication methodologies in connection with particular components and/or processes should not be construed to limit the scope of the invention in any way.

In at least some instances, one or more of the communication methodologies pertain to communications between the terminals and the data center (see FIG. 2). With respect to one particular implementation, communications initiated at the terminal are implemented in either a real-time mode, or a JIT mode. In exemplary real-time and JIT implementations, each product provided by, or made available by way of, the terminal, has a unique associated code, which may comprise letters or numbers or both, that identifies the particular communications methodology to be implemented with respect to communications concerning that product. Thus, when a consumer uses the terminal to request a particular product, the terminal accesses the code associated with that product and then initiates the corresponding communication, guided by the relevant communications methodology. A particular communications methodology may however, be invoked in various other ways as well. For example, it may be desirable in some instances to define a relationship between the sender and/or receiver of the communication and the particular communications methodology to be employed.

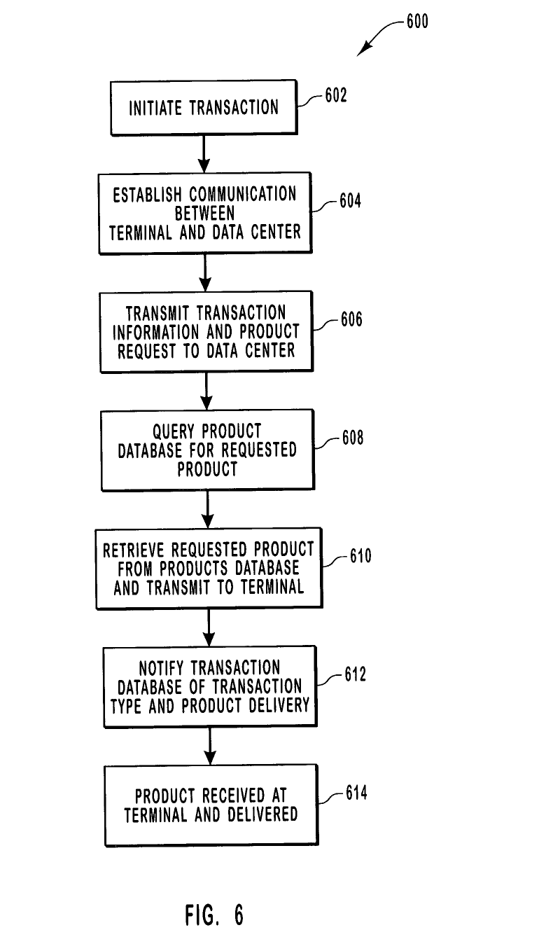

Directing attention now to FIG. 6, details are provided concerning an exemplary communications methodology, denoted generally at 600, for implementing a real-time transaction or related process. Such real time functionality is particularly useful in the context of the execution of PINless transactions, and also finds application in immediate crediting environments where delivery of a product is contingent upon the prior receipt of payment.

In at least some implementations of process 600, all of the events that comprise such process 600 are performed in real time, or substantially in real time. However, in other implementations of process 600, one, or only some, events are performed in real time, or substantially in real time.

Moreover, while the process 600 is described below with reference to a transaction concerning prepaid services, general aspects of the process 600 may be employed in other cases as well. For example, evolutions such as training, transmission and/or replenishment of marketing materials, and creation and printing of reports can also be performed on a real-time, or substantially real time, basis as well.

In the illustrated embodiment, the process 600 commences at stage 602 where a transaction is initiated by a user, such as a clerk or manager, at the terminal. Exemplarily, the transaction is initiated when the user selects a product from a menu displayed on the terminal. After the transaction has been initiated, the process 600 advances to stage 604 where communication is established between the terminal and the data center communications server. At stage 606, the terminal transmits transaction information and the product request to the communications server. Upon receipt of such transaction information and product request at the communications server, the process 600 advances to stage 608 where the communications server queries the product database for the requested product.

After identification of the requested product, the process 600 advances to stage 610 where the requested product is retrieved from the product database and transmitted to the terminal. Following retrieval and transmission of the requested product, the process 600 advances to stage 612 where the transaction database is notified of the transaction type and product delivery. At stage 614, the terminal receives the product from the data center and delivers the product to the manager or other personnel. In some exemplary implementations of process 600, a credit or debit card authorization process is performed prior to delivery of the product so that no product is delivered until after the consumer account has been charged.

While the real time communications methodology is useful in many cases, as discussed above in connection with process 600, it is desirable to employ the JIT communications methodology in other cases. In typical implementations of the JIT communications methodology, the product and PIN inventories are positioned at the terminal. Replacement products and/or PINs for those drawn down from the pre-loaded terminal inventory are obtained from the data center only when a specific demand for the such products and/or PINs has been identified. In this way, the product and/or PIN are provided ‘just in time’ to meet the demand defined by the transaction request made at the terminal.

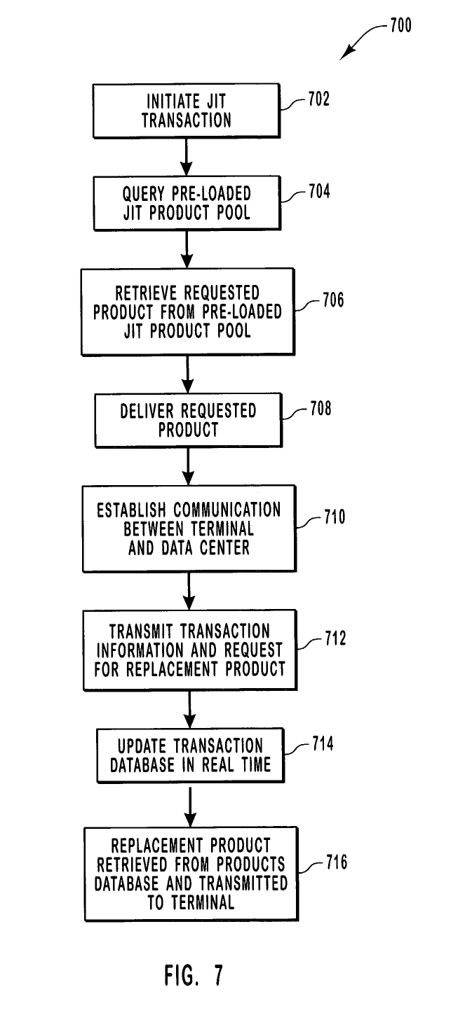

Directing attention now to FIG. 7, details are provided concerning an exemplary communications methodology, denoted generally at 700, for implementing a JIT transaction, or similar process. In the exemplary implementation illustrated in FIG. 7, the process 700 concerns communications between a terminal and the data center. However, the scope of the invention is not so limited.

The illustrated embodiment of the process 700 commences at stage 702 where a transaction is initiated at the terminal when, for example, a product is selected from a menu displayed on the terminal. At stage 704, the terminal queries the pre-loaded JIT products pool located at the terminal. In the event that the requested product is not available for some reason, the terminal displays a corresponding message. The message may indicate simply that the requested product is not available, and may request the user to select another product. In another implementation, the message additionally recommends one or more alternate products to the user. If the requested product is available, the process 700 advances to stage 706 where, the requested product and/or PIN is retrieved from the JIT products pool. At stage 708, the requested product is delivered to the manager or other user. Exemplarily, the delivered product comprises a prepaid service card, or ‘cardback.’ However, in other cases, the delivered product may comprise, among other things, a PIN, wireless telephone air time replenishment, wireless telephone service activation, or any of a variety of other products.

Following delivery of the product, the process 700 advances to stage 710 where communication is established between the terminal and the data center. At stage 712, the terminal transmits transaction information, as well as a request for a replacement product of like type and denomination as the delivered product. Upon receipt of the transaction information by the data center, the process advances to stage 714 where the transaction database is updated in real time, or on some other basis.

At stage 716, the requested replacement product is retrieved from the products database at the data center and transmitted to the terminal. In some exemplary implementations of process 700, a credit or debit card authorization process is performed prior to delivery of the product so that no product is delivered until after the consumer account has been charged. Provision is further made in some cases for transmitting a message from the terminal to the data center, confirming receipt of the replacement product and corresponding PIN.

In some implementations, the replacement product transmitted to the terminal is substantially the same as the product initially delivered. However, the replacement product may alternatively comprise a product different from the initially delivered product. Such a situation may occur, for example, where the delivered product was the last of its type and whose place is being taken by a substitute product. In yet other cases, the replacement product differs from the initially delivered product in accordance with a request made by the merchant.

In one alternative embodiment, updates to the inventory located at the terminal may be implemented based on historic sales figures and/or other data, rather than in response to requests made by the terminal. In this way, updates to the terminal inventory would be implemented automatically without necessitating specific requests by the terminal each time a replacement product is required.

As suggested by the foregoing, the JIT communications methodology provides useful functionality in many circumstances. For example, the JIT communications methodology benefits the merchant and carriers, among others, by providing a PIN and/or product on demand, that is, only at the time when an actual transaction request has been initiated.

Further, the JIT communications methodology permits dynamic assessments of PIN and product inventory located at the terminal and at the data center. In this regard, it should be noted that use of the JIT communications mode can be implemented not only with respect to PINs or particular products, but also at various other levels within a given product hierarchy such as, but not limited to, the product type, denomination, and carrier. Thus, the JIT communications mode permits, for example, dynamic assessments, and corresponding reporting, to be performed concerning all XYZ Wireless Co. prepaid card transactions that have an associated denomination of $20.00.

Thus, each time a PIN is issued to a customer in conjunction with issuance or replenishment of a prepaid services card, for example, implementation of that transaction in the JIT communications mode ensures that the change in PIN inventory is noted, so that the PIN inventory at the terminal can be appropriately replenished. Information concerning such changes to one or more PIN inventories can be disseminated periodically, or on some other basis, to the merchant, broker, carriers and others, for use in performing trend analyses, making marketing and purchasing decisions, and performing various other processes.

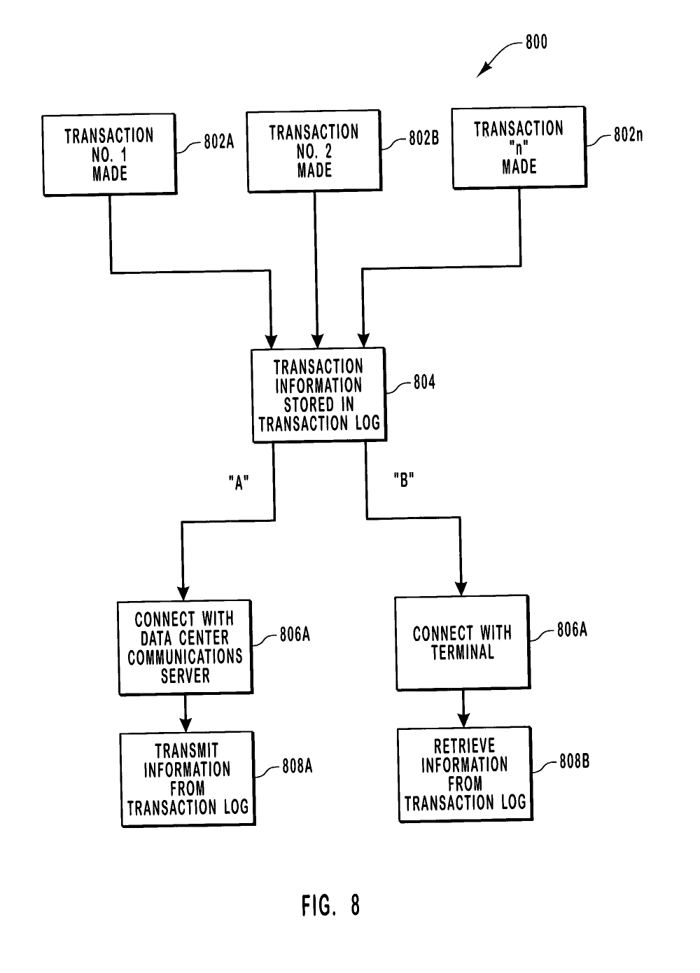

As an alternative to the JIT and real time communications mode, it may be useful in some situations to implement communications concerning the VASN 100 (see FIG. 1) and VASN operating environment 200 in a batch mode. Aspects of one exemplary implementation of a batch mode communication methodology are illustrated in FIG. 8, where the communication process is denoted generally at 800.

In the illustrated implementation, various transactions are executed at stages 802A, 802B and 802n. As each transaction is executed, information concerning that transaction is stored in a transaction log, as indicated by stage 804. Upon the satisfaction of various predetermined criteria, the process advances to either stage 806A or stage 806B, depending upon, respectively, whether it is desired to upload the batched transaction information to the data center, or whether it is desired to download the batched transaction information from the terminal. The criteria for determining the stage to which process 800 will advance after stage 804 include, for example, the passage of a predetermined period of time, the storage of transaction information concerning a predetermined number ‘n’ of transactions, or the arrival of particular time and/or date.

In the event that it is desired to upload the batched transaction information to the data center, the process 800 advances to stage 806A where a connection is established between the terminal and the data center. At stage 808A, the batched transaction information in the transaction log is transmitted, or uploaded, to the data center from the terminal. In at least some cases, the batched transaction information is also sent to a remote host. More generally, such batched transaction information may be copied or backed up to any other location as necessary to suit the requirements of a particular application or operating environment, or other factors.

On the other hand, if it is desired to download the batched transaction information from the terminal, the process advances to stage 806B where a connection is made between the data center and the terminal. The process 800 then advances to stage 808B where the batched transaction information in the transaction log is retrieved, or downloaded, from the terminal by the data center. The batched transaction information may, in some implementations, also be retrieved from the terminal by a remote host.

Through the use of the foregoing, and other, communications methodologies, embodiments of the invention are effective in implementing a variety of transactions concerning various different product types. As discussed below, the implementation of such transactions is further advanced through the use of a flexible and adaptable product definition scheme.

VI. General Aspects of Exemplary Product Structures and Groupings

One aspect of embodiments of the invention is that they are flexible in terms of the products and product mix that can be offered by way of the terminal. Such flexibility is achieved, at least in part, through a dynamic product hierarchy that is defined in such a way as to readily admit of changes to the products and product mix associated with a particular terminal.

One exemplary hierarchy includes, at the top of the hierarchy, a product type level wherein such product types generally include any type of product that may be offered through the terminal such as, but not limited to, long distance service, wireless air time, and home dial tone minutes. The remainder of this exemplary hierarchy includes, arranged from the product type level to the bottom of the hierarchy, a product level where the particular product is specified, a denomination level that specifies the denomination associated with that product, and a PIN level that specifies, for example, a specific PIN that applies to a particular product. Exemplarily, one or more levels of the hierarchy have corresponding screen displays that can be viewed by the user as the transaction progresses. Of course, various other hierarchies may be devised and employed as may be necessitated by the requirements of a particular application or operating environment.

Because the aforementioned hierarchy is nonspecific, it is relatively easy to add new products to the system simply by specifying the basic elements identified in the hierarchy. Among other things, this flexibility gives merchants, brokers, and others the ability to dynamically adjust product offerings quickly and easily.

VII. Aspects of Exemplary Transactions

As noted elsewhere herein, a variety of product transactions may be performed in conjunction with embodiments of the invention. Specific examples of such product transactions include, among others, wireless transactions, unique denomination transactions, and home dial tone transactions. The following discussion will consider various aspects of some exemplary transactions.

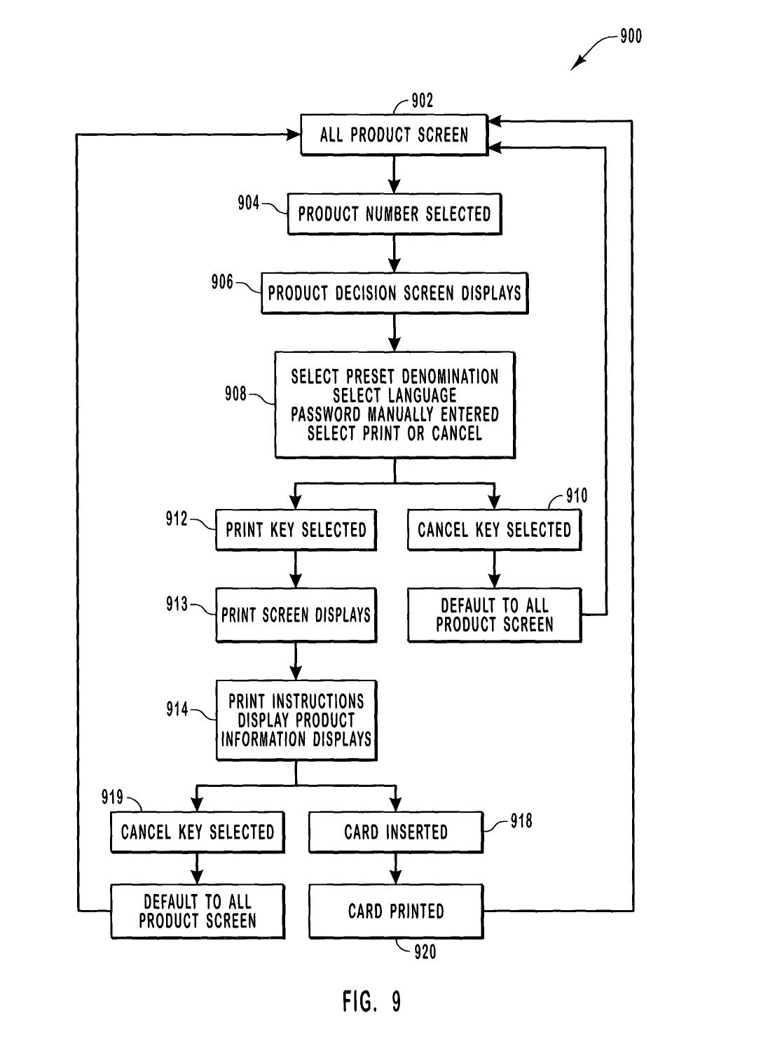

Attention is directed first to FIG. 9 which illustrates general aspects of an exemplary transaction process 900 that can be executed, either in whole or in part, by either the consumer or the merchant. At the initial stage 902 of process 900, the terminal displays an ‘all product’screen which includes all the products that may be purchased by way of that terminal. As noted elsewhere herein, the product mix available through any given terminal is dynamic, so that the scope and mix of products displayed on the ‘all product’ screen may change from time to time in accordance with the availability of certain products and/or the desires of the merchant, carrier, broker, or other participant.

After the products are displayed on the screen, the process 900 advances to stage 904 where the user selects a number corresponding to the desired product. The process then advances to stage 906 where the terminal, in response to the product selection made by the user, displays various product decision screens. In at least some instances, such product decision screens generally concern one or more elements of the product hierarchies described above, such as, but not limited to, the product type, a particular product, a desired denomination, and a PIN corresponding to the desired product. The product decision screens may additionally, or alternatively, concern other product-related aspects such as the available wireless service providers, the language desired to be used to effect the transaction, password selection, and purchase options such as a new card purchase, or replenishment of an existing card.

At such time as the appropriate product decision screen, or screens, are displayed, the process 900 advances to stage 908 where the user makes the appropriate decisions concerning the desired product. Also at stage 908, the user has the option to select, in the exemplary case where a prepaid service card has been requested, whether to print the desired prepaid services card, or cancel the transaction. If it is desired to cancel the transaction, the process 900 advances to stage 910 where the ‘cancel’ key of the terminal is selected, and then resets to stage 902 where the ‘all product’ screen is displayed in readiness for initiation of another transaction.

If, on the other hand, it is desired to print the desired prepaid services card, the process 900 advances to stages 912 and 913 where the ‘print’ key of the terminal is selected and the print screen is displayed, respectively. Next, stage 914 is entered where print instructions and product information are displayed. At this point in process 900, the user, merchant, or other party, still has the option to cancel the transaction. If it is desired to cancel the transaction at this point, the process 900 advances to stage 916 where the ‘cancel’ key of the terminal is selected, and then resets to stage 902 where the ‘all product’ screen is displayed in readiness for initiation of another transaction.

However, if it is desired to complete the transaction, the process advances to stage 918 where the card is inserted into the terminal for printing. The process 900 then terminates at stage 920 when the card is printed. After printing, the process 900 resets to stage 902 where the ‘all product’ screen is displayed in readiness for initiation of another transaction.

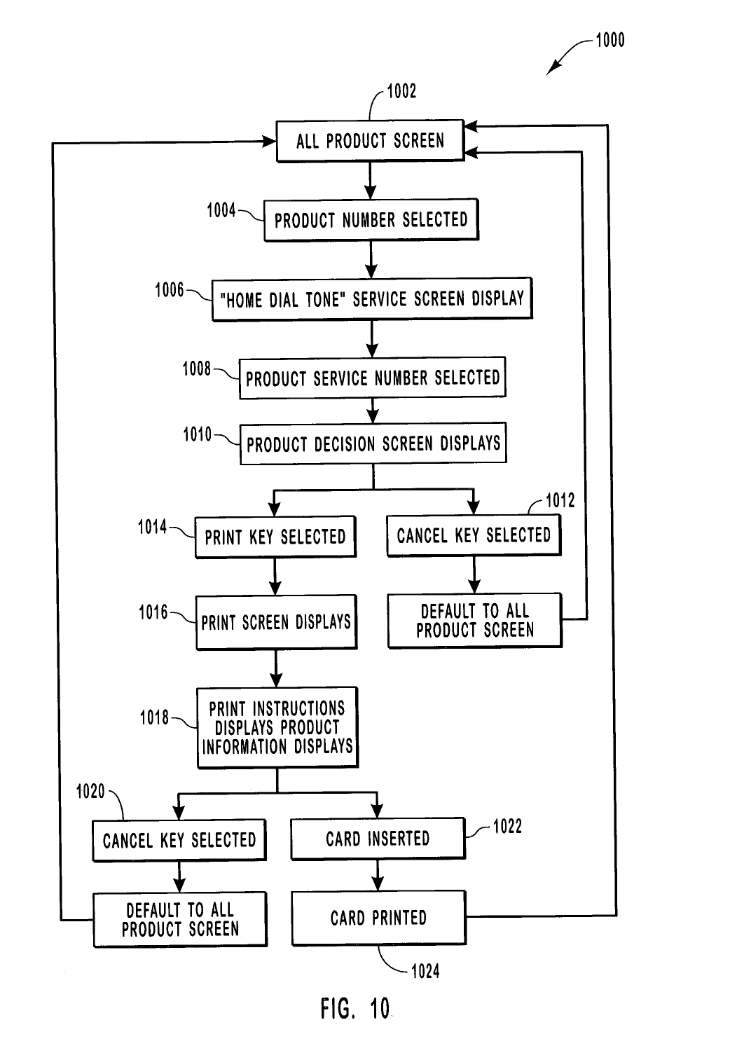

With attention now to FIG. 10, details are provided concerning one specific transaction that may be implemented. More particularly, aspects of a home dial tone transaction process 1000 are illustrated. In many regards, the home dial tone transaction process illustrated in FIG. 10 is similar to the generalized transaction process illustrated in FIG. 9. Accordingly, the following discussion will focus primarily on certain differences between the respective processes.

Generally, stages 1002 and 1004 of process 1000 are substantially the same as stages 902 and 904 of process 900. After the product number is selected at stage 1004, the process 1000 advances to stages 1006 and 1008 where, respectively, the product service screen for home dial tone service is displayed and the product service number corresponding to home dial tone service is selected by the user. The product service screen exemplarily displays information such as the home dial tone product name and the corresponding service number.

Upon selection by the user of the service number, the process 1000 advances to stage 1010 where the product decision screen is displayed. As noted above in connection with the discussion of process 900, the product decision screen may present information and choices concerning aspects of the product such as, but not limited to, the product type, a particular product, a desired card denomination, a PIN corresponding to the desired product, the language desired to be used to effect the transaction, password selection, and purchase options such as a new card purchase, or replenishment of an existing card.

The remainder of the stages 1012 through 1024 illustrated in FIG. 10 are substantially comparable to stages 910 through 920 of process 900 illustrated in FIG. 9. Accordingly, no further discussion of the events represented by stages 1012 through 1024 is presented at this juncture.

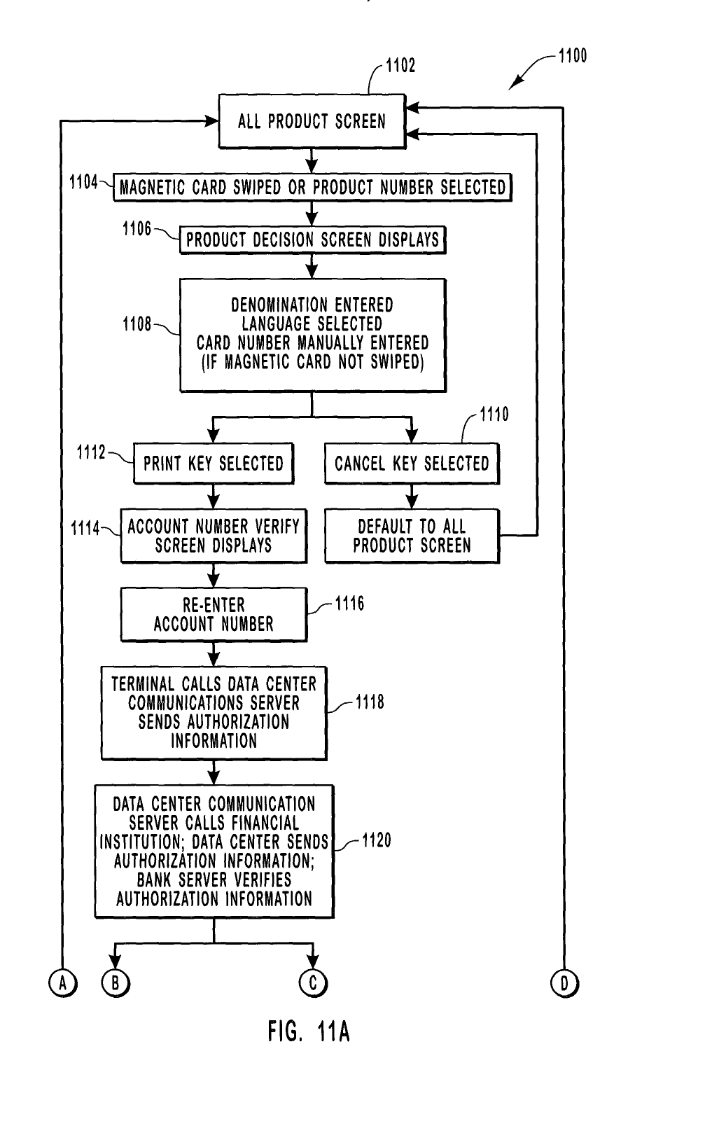

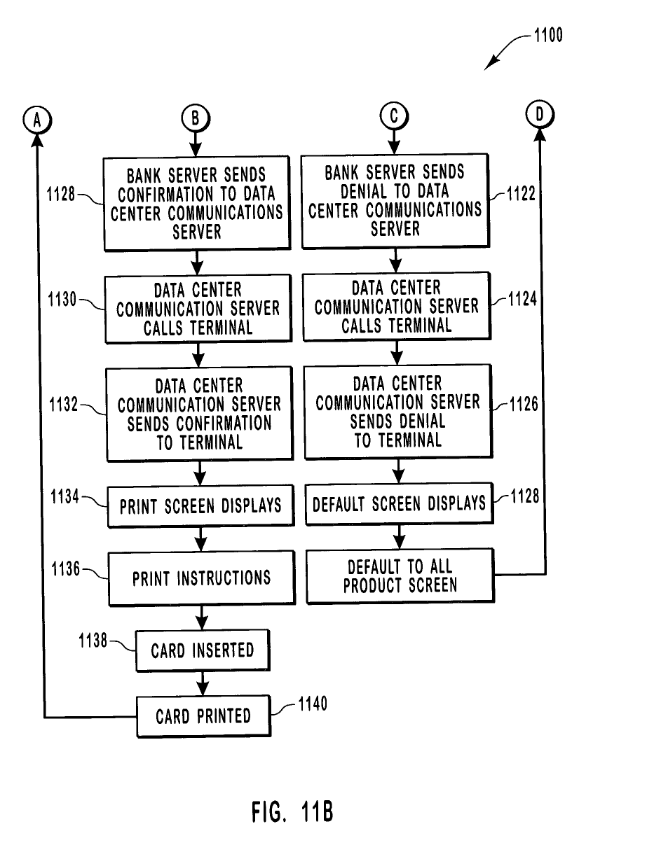

In addition to the aforementioned exemplary transactions, various other transactions, such as unique denomination transactions, may also be implemented. Moreover, it was noted earlier that portions of at least some transactions may be implemented by way of the magswipe card reader of the terminal. Directing attention now to FIGS. 11A and 11B, details are provided concerning an exemplary embodiment of one such transaction, in particular, a unique denomination magswipe transaction process, denoted generally at 1100.

As in the case of at least some other transactions, the unique denomination magswipe transaction process 1100 initially begins at stage 1102 where the all product screen is displayed at the terminal. At stage 1104, a magnetic card such as a debit or credit card is swiped, causing the product decision screen to be displayed at stage 1106. In general, the product decision screen exemplarily presents information and choices concerning aspects of the product such as those discussed above in connection with processes 900 and 1000. The process 1100 then advances to stage 1108 where the user enters various information consistent with the product decision screen display. If, at this point, the user decides to cancel the transaction, stage 1110 is entered where the ‘cancel’ key is selected and the process then resets to stage 1102.

On the other hand, if the user desires to proceed with the transaction, the process 1100 advances to stage 1112 where the ‘print’ key is selected. An account number verify screen is then displayed at stage 1114 that requests the user to re-enter, either manually or by magswipe, the user account number, which is performed at stage 1116. The process 1100 then advances to stage 1118 where the terminal contacts the data center communications server and sends authorization information indicating that the user has authorized a charge to be made against the swiped card. At stage 1120, the data center communications server contacts the appropriate financial institution and sends the authorization information to the financial institution server. The financial institution then evaluates the authorization information and sends either a confirmation or a denial to the data center communications server.

More particularly, if the financial institution determines that a denial is necessary, the a process 1100 advances to stage 1122 where the financial institution server sends a denial to the data center communications server. At states 1124 and 1126, respectively, the data center communications server contacts the terminal, and transmits the denial to the terminal, causing the terminal to display the denial screen at stage 1128. The process 1100 then resets to stage 1102.

If, on the other hand, the financial institution determines that a confirmation is appropriate, the process 1100 advances to stage 1128 where the financial institution server sends a confirmation to the data center communications server. At states 1130 and 1132, respectively, the data center communications server contacts the terminal, and transmits the confirmation to the terminal, causing the terminal to display the print screen at stage 1134. Exemplarily, the print screen displays the selected language, card denomination, and product name, although additional or alternative information may likewise be displayed. At states 1136, 1138 and 1140, respectively, the print instructions are presented, the card inserted into the terminal, and then printed. The process 1100 then resets to stage 1102.

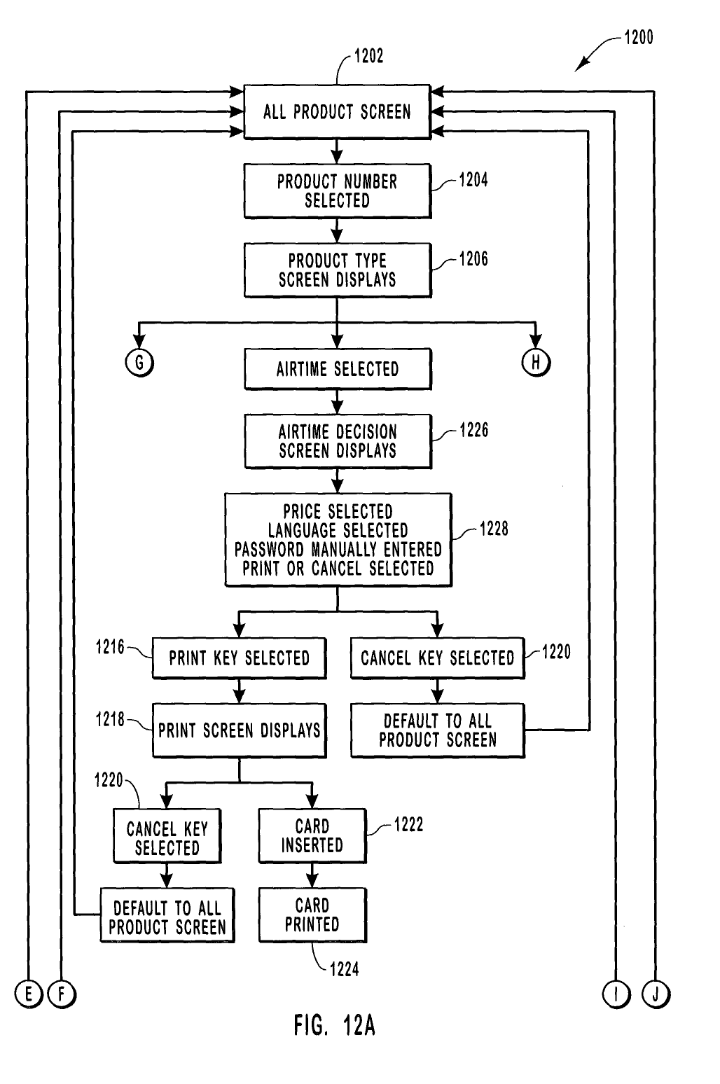

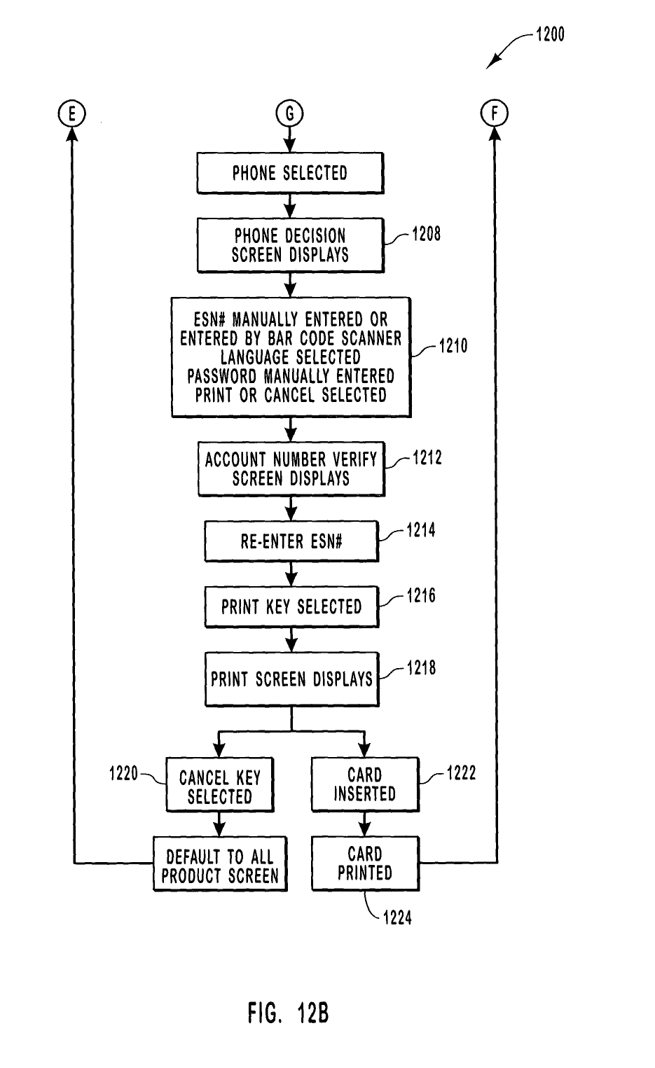

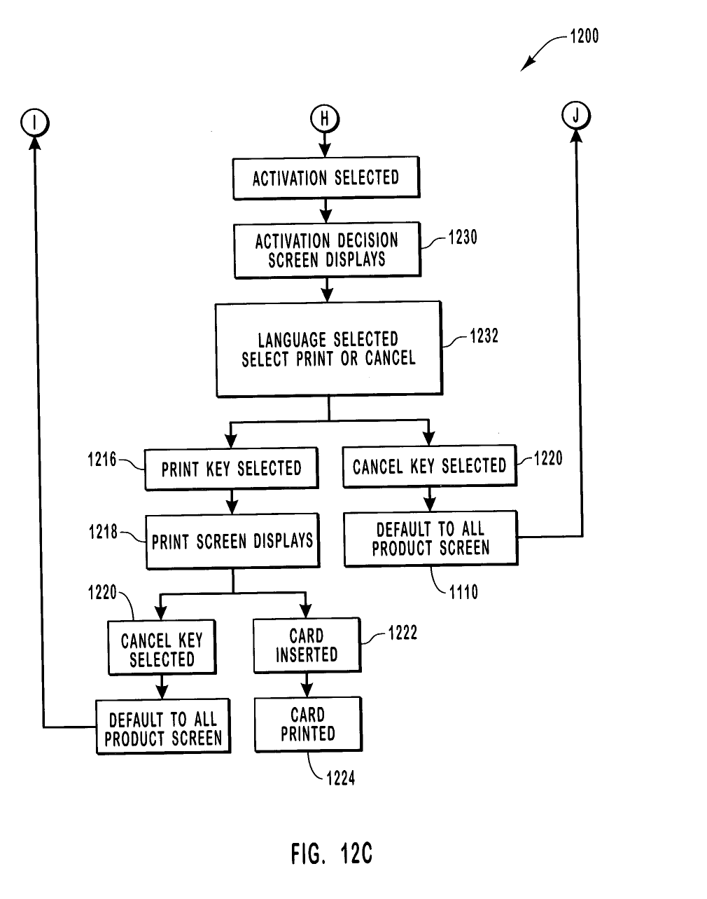

Directing attention now to FIGS. 12A through 12C, various aspects of exemplary implementations of transactions concerning wireless phone services and related products are considered. The exemplary process for implementing such transactions is generally denoted at 1200. Initially, the process 1200 is at stage 1202 where the ‘all product’ screen is displayed. The process 1200 then moves to stage 1204 where the user selects a product number corresponding to the desired product. In this exemplary implementation, the user has the option of choosing to purchase a wireless phone, wireless air time, or activation of wireless service. After the selection has been made, the process moves to stage 1206 where the product type screen appears and displays the name of the selected wireless product. The remainder of process 1200 is then determined by the particular wireless product that has been selected.

In the event that the wireless product selected is a wireless phone, the process 1200 advances to stage 1208 where the phone decision screen is displayed. In this exemplary implementation, the phone decision screen displays the phone product name and prompts the user to enter a password, enter an ESN#, either manually or by bar code scanner, select a language, and select ‘print’ or ‘cancel’ for the transaction. At stage 1210, the user enters the information requested by the displayed phone decision screen. In response, stage 1212 is entered where the ‘account number verify’ screen is displayed requesting verification of the ESN#. The user, at stage 1214, re-enters the ESN# either manually or by barcode and, at stage 1216, selects the ‘print’ key. The print screen is displayed at stage 1218 and, exemplarily, indicates to the user how to insert the card into the terminal, denotes the selected language, lists the denomination product name or product name service, and gives the user the option to either print the card or cancel the transaction.

If the user desires to cancel the transaction, stage 1220 is entered wherein the user selects the ‘cancel’ key. The process 1200 then resets to stage 1202. If the user elects to continue with the transaction however, the process 1200 advances to stage 1222 where the user inserts the card into the terminal. At stage 1224, the card is printed and the process 1200 then resets to stage 1202.

It was suggested above that at least some aspects of the process 1200 may vary depending upon the particular product selected by the user. Directing continuing attention to FIGS. 12A through 12C, details are provided concerning an implementation of process 1200 wherein the selected product comprises wireless air time. Upon selection of wireless air time by the user, the process 1200 advances to stage 1226 where the air time decision screen is displayed. In this exemplary implementation, the air time decision screen displays the wireless product name and prompts the user to enter a password, select a language and denomination, and select ‘print’ or ‘cancel’ for the transaction. At stage 1228, the user enters the information requested by the displayed phone decision screen. The remainder of the process 1200 concerning wireless air time proceeds substantially in accordance with states 1216 through 1224, described above in connection with the purchase of a wireless phone.

In addition, or as an alternative, to facilitating transactions concerning wireless phones and wireless telephone air time, implementations of process 1200 are also employed to enable a consumer to activate a wireless telephone service account. In this implementation, selection of wireless telephone service account activation by the user causes the process 1200 to advance to stage 1230 where the activation decision screen is displayed. Among other things, the activation decision screen displays the phone product name and prompts the user to enter a password, select a language, and select ‘print’ or ‘cancel’ for the transaction. At stage 1232, the user enters the information requested by the displayed phone decision screen. The remainder of the process 1200 concerning wireless service account activation proceeds substantially in accordance with states 1216 through 1224, described above in connection with the purchase of a wireless phone.

VIII. Aspects of Exemplary Card Back Process

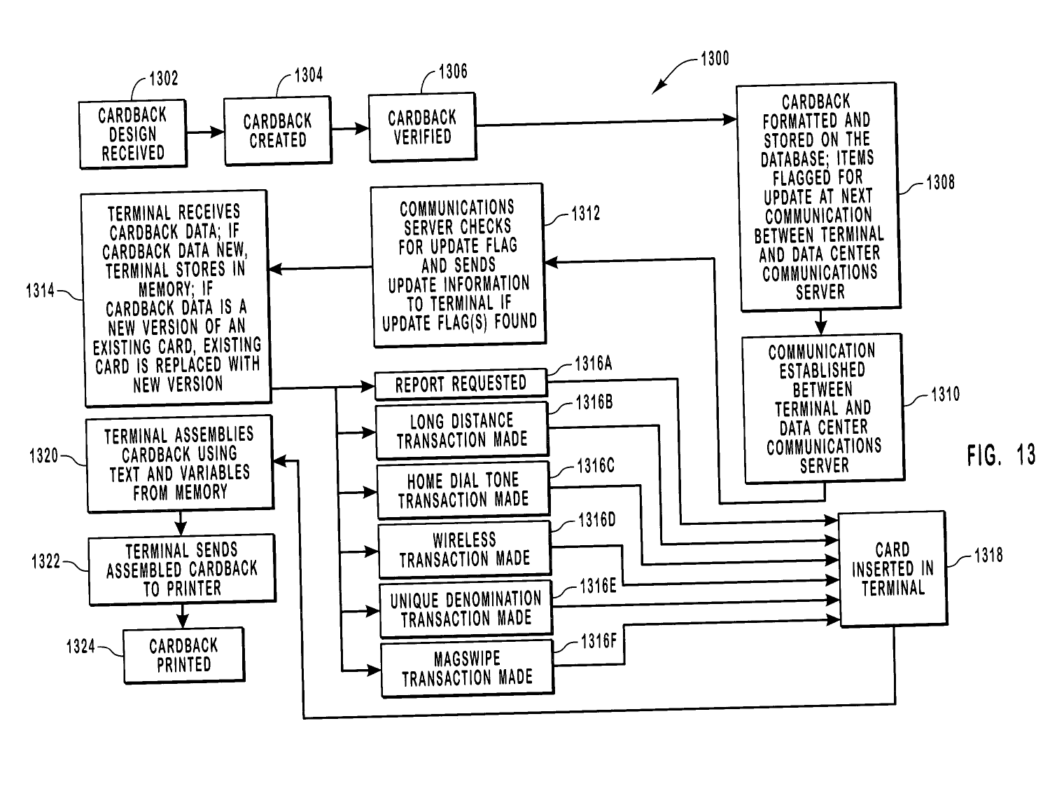

In many of the exemplary transactions disclosed herein, the final portion of the transaction process involves generation of a prepaid services card for use by a consumer. While aspects such as the product type, denomination, language, and/or other aspects, may vary somewhat from one prepaid services card to another, the creation of such prepaid services cards generally proceeds in a similar manner in any event. With attention now to FIG. 13, details are provided concerning an exemplary process, denoted generally at 1300, for creating and printing a prepaid services card.

The initial stages of the process 1300 are generally concerned with the design, creation and storage of the cardback. More particularly, at stage 1302, the cardback design is received at a predetermined location, such as the data center communications server. The cardback is then created at stage 1304, consistent with the received design. Verification of the cardback thus created is performed at stage 1306. In general, such verification serves to ensure that the created cardback conforms with the specified design. Aspects of an exemplary cardback design include, but are not limited to, the denomination, language, carrier, prepaid services product, and merchant, associated with the card. More generally however, any other aspects, or combinations thereof, concerning a prepaid services transaction may be employed in the design of a cardback. In this regard, it should be noted that each prepaid services product may have multiple associated cardback formats.

After verification of the cardback, the process 1300 advances to stage 1308 where the cardback is formatted and stored in a database. Exemplarily, the database is located at the data center, but may alternatively be located at a terminal or other location. Also at stage 1308, various aspects of the cardback are flagged. Generally, the flagged aspects of the cardback comprise features of a variable nature that may be desired to be changed or modified in some way from time to time. By way of example, if the carrier name or service is a flagged item, a notice from the carrier that its name or particular service has changed, it would typically be desirable to update the cardback to reflect such changes.

At some time subsequent to flagging, the process 1300 advances to stage 1310 where communication is established between the data center communications server and the terminal. Generally, such communication permits transmission of one or more cardbacks to the terminal, as well as allowing transmission of any updates concerning cardbacks already stored at the terminal. More particularly, stage 1312 is entered where the communications server checks for any update flags and sends update information to the terminal if any update flags are present. In addition, or alternatively, the communications server also sends one or more cardbacks to the terminal.

Next, the process 1300 enters stage 1314 where in the terminal receives the cardback data transmitted by the data center communications server. Typically, such cardback information is stored at the terminal in a ‘disassembled’ form, rather than as a complete cardback. If, for example, the cardback data is new, the terminal simply stores the new cardback data in the local memory. On the other hand, if the cardback data comprises a new version of a cardback, such as may be necessitated by the presence of one or more update flags, already present in the local memory, the terminal replaces the existing cardback with the new cardback. The new cardback, and any other cardbacks, are then held in readiness for use in connection with various transactions 1316 initiated at the terminal, such as those disclosed elsewhere herein.

As suggested in FIG. 13, such transactions 1316 may include, but are not limited to, a report request 1316A, a long-distance transaction 1316B, a home dial tone transaction 1316C, a wireless transaction 1316D, a unique denomination transaction 1316E, and a magswipe transaction. 1316F. Note that a particular transaction may incorporate elements of one or more of the foregoing examples. For example, a home dial tone transaction may also have an associated unique denomination.

After a transaction has been initiated, the process 1300 moves to stage 1318 where the user is prompted to insert a card into the terminal. Upon insertion of the card, the process 1300 advances to stage 1320 where the terminal assembles a cardback using corresponding information stored in the terminal memory. More particularly, the terminal gathers from its memory the cardback information needed to produce the required cardback and then assembles that information together to form the cardback. The terminal, at stage 1322, then sends the assembled cardback to the terminal printer and, at stage 1324, the cardback is printed.

While a wide variety of cardbacks may be defined, as suggested by the disclosure herein, such cardbacks typically share some common attributes. For example, many cardbacks include a fixed field that includes various instructions concerning their use and application. Such cardbacks also typically include one or more variable fields. For example, each cardback generally includes an associated PIN number. Further, the cardbacks also typically include, or have associated therewith, a control number or ESN#. Of course, various other cardback configurations may comprise different combinations of fixed and variable fields.

IX. Aspects of Exemplary Reports and Related Processes

Yet other aspects of embodiments of the invention concern the various activity reports that can be defined and generated concerning one or more aspects of prepaid services transactions such as those disclosed herein. Aspects of such reports can be defined, or otherwise configured, in various ways to suit the requirements of a particular application or operating environment and may, exemplarily, be defined by a merchant ‘on-the-fly’ at the terminal, by brokers and operators, or at the data center. As one example, a manager can, in some implementations, define shift start and end times to be used in the generation of an end-of-shift report.

More generally however, a virtually unlimited number and type of reports can be defined by various personnel at different locations within, or associated with, the VASN 100. Accordingly, it should be noted that the reports and associated processes disclosed herein are exemplary only and are not intended to limit the scope of the invention in any way.

With respect to particular report definitions, reports can be configured so that some formats are available only to a manager, while yet other reports are directed to the clerk level. Further, various reports can be generated for the use and information of other participants, such as the carrier or broker for example. Some exemplary report formats are based on a predetermined timeframe, such as end-of-shift and end-of-day reports.

Additionally, such reports may include a variety of information. Examples of information and information types that may be included in one or more reports include, but are not limited to, the product name, the product denomination, the number of cards sold, the product grand total, the shift date, the shift start and end times, the store location, the day, week and month totals, ACH totals by shift, day, week, month or other time period, and the margin.

The foregoing, and other, information contained in a report can be sorted in any of a variety of different ways, depending upon the desires of the user, or other factors. Moreover, the information contained in, or used to define, one or more reports may be stored in various locations. Thus, exemplary reports may be based on information located at the terminal, at the data center communications server, or both, or elsewhere.

Reports such as those described above can be used for a variety of purposes. For example, a merchant may use some reports to perform various trend analyses concerning the sale of prepaid services cards. As another example, reports may prove useful in enabling the merchant to develop store budgets and other planning materials. Other participants may likewise benefit from reports. By way of example, operators and brokers may use sales reports as an aid in determining the potential success of a new prepaid services offering at one or more merchant locations. Consistent with the foregoing, reports may be generated and/or accessed at a variety of locations in the VASN operating environment 200 and the foregoing reports provided by way of the terminal are, accordingly, exemplary only and are not intended to limit the scope of the invention in any way.

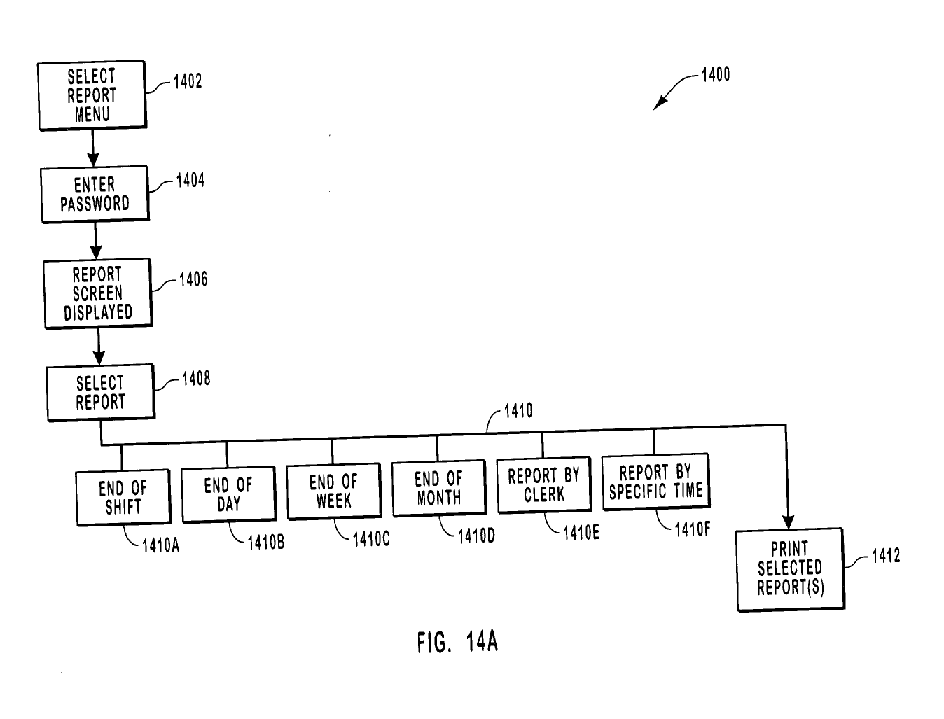

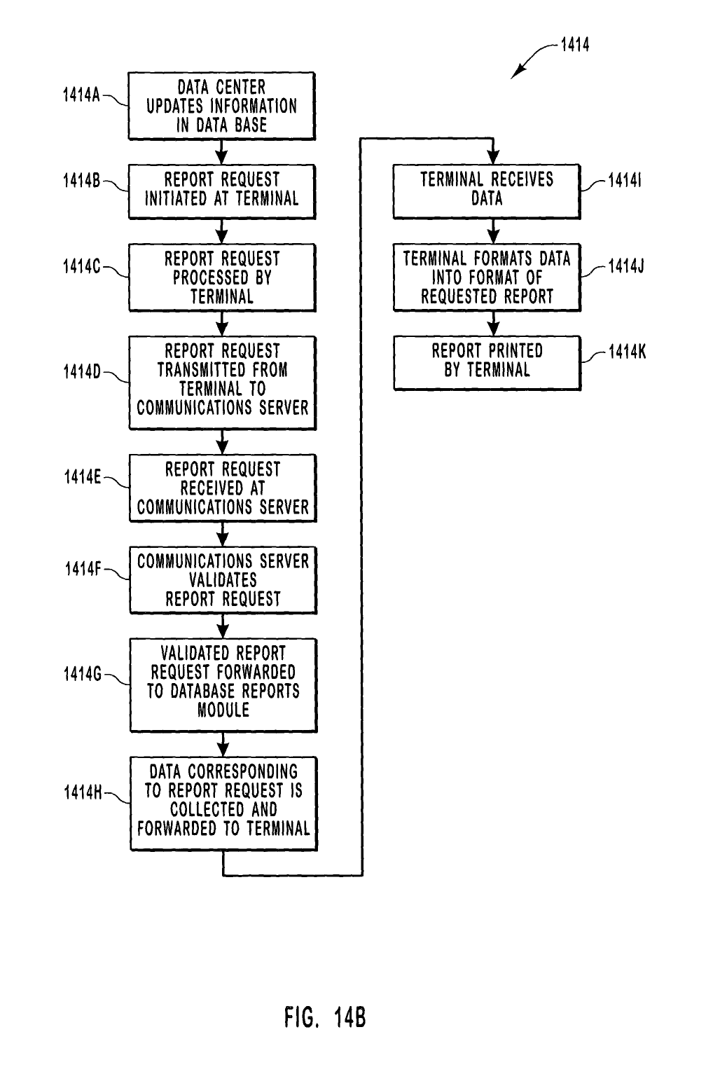

Attention is directed now to FIG. 14A where various general aspects of an exemplary report selection and reporting process 1400 are presented. In general, the process 1400 is concerned with an exemplary sequence of events that occurs at the terminal with regard to a report request. Details concerning aspects of the interaction between the terminal and the data center in the event of such a request are considered below in connection with the discussion of FIG. 14B.

Initially, the process 1400 illustrated in FIG. 14A begins at stage 1402 where a user desiring a report selects the report menu. As noted earlier, aspects of the reports and report menus, such as form and content, may be predefined or, alternatively, may be specified on an ad hoc basis. Moreover, such aspects may be specified and/or defined locally at the terminal, remotely at the data center, and/or elsewhere.

At stage 1404, the user is prompted to enter a password. Upon entry of an appropriate password by the user, the process 1400 advances to stage 1406 where a report screen is displayed. Generally, the report screen displays the various reports available for access by the user. Thus, in this exemplary implementation, the particular reports that will be displayed are indexed to the password entered at stage 1404. For example, if the terminal recognizes the password as corresponding to a clerk, only those reports that a clerk, or that particular clerk, is authorized to view and print will be displayed as menu options on the report screen. As another example, the location of a particular terminal by way of which reports are requested, and/or the merchant with which such terminal is associated, may serve to at least partially determine the reports available by way of that terminal.

With continuing reference to FIG. 14A, the process 1400 advances to stage 1408 where the user selects one or more reports 1410 displayed on the terminal screen. Exemplarily, such reports 1410 may include, among others, an end-of-shift report 1410A, an end-of-day report 1410B, an end-of-week report 1410C, an end-of-month report 1410D, a report by clerk 1410E, and a report by specific time 1410F. As suggested earlier, the scope, type, format, and content of such reports 1410 are virtually unlimited. Thus, the indicated brief list of exemplary reports is not intended in any way to comprise an exhaustive enumeration of the reports that may be defined, employed and printed in connection with the implementation of embodiments of the invention. After a report 1410 has been selected, the process advances to stage 1412 where the selected report is printed by the terminal.

Directing attention now to FIG. 14B, details are provided concerning aspects of the interaction between the terminal and the data center in the event that a report is requested through the terminal. Such interaction is denoted generally as process 1414 in FIG. 14B.

Typically, the data center operates in the background at stage 1414A, updating information contained in the data center database. Among other things, such updates concern sales, product inventory, and terminal metrics. As noted elsewhere herein, such updates may be performed in real time, batch, or JIT modes, or in any other suitable mode. One aspect of a real time database update mode is that the merchant is able to receive dynamic reporting of transactional data in real time at the terminal.

At stage 1414B, a report request is initiated at the terminal, causing the process 1414 to advance to stage 1414C where the report request is processed by the terminal. Exemplarily, such processing of the report request by the terminal may include, among other things, formatting the report request so that it is suitable for transmission, verifying the functionality of the communications hardware, and initializing, the communications hardware and/or software to support transmission of the report request. Upon completion of the processing of the report request, the process 1414 advances to stage 1414D where the report request is transmitted from the terminal to the data center communications server.

After the report request is received at the communications server at stage 1414E, the process 1414 enters stage 1414F where the communications server validates the received report request. Such validation may include, among other things, ensuring that the report request is in the proper format. After validation, the process 1414 enters stage 1414G where the validated report request is forwarded to the database reports module. In response, stage 1414H of process 1414 is entered and the database reports module collects the requested data from the database and forwards the collected data to the requesting terminal. At states 1414I and 1414J, respectively, the data is received at the terminal, and then formatted into the requested report format. The process 1414 then advances to stage 1414K and the requested report is printed at the terminal.

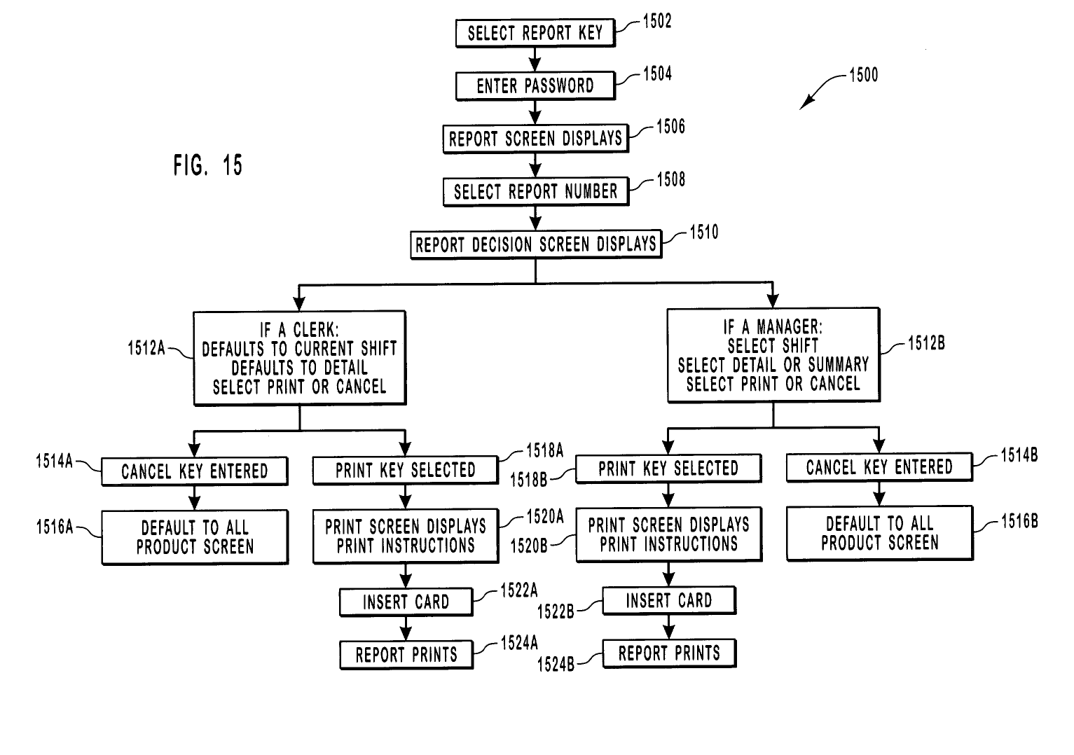

With attention now to FIG. 15, further details are provided concerning one specific example of a process 1500 where a user requests a report by way of the terminal. Initially, the process 1500 is entered at stage 1502 where the user or operator of the terminal selects the ‘report’ key indicating that the user wishes to access the report menu or menus. In this exemplary implementation, such access is predicated upon entry of an appropriate password by the user at stage 1504. After the terminal has received and verified the entered password, the process 1500 moves to stage 1506 where the report screen is displayed.

Generally, the report screen presents various report options, one or more of which may be selected by the user. In at least some cases, the particular combination of displayed report options is indexed to the password, as described earlier. Examples of merchant report options that may be presented include reports associated with a particular shift, day, week, month, time, clerk or control number. Another exemplary report provides data concerning a predetermined number of prior transactions. For example, a user could request a report that includes information concerning the previous ten transactions implemented through that terminal.

Upon selection of a report at stage 1508, the process 1500 advances to stage 1510 where the report decision screen is displayed. In this exemplary implementation, the contents of the report decision screen correspond to the identity of the user. For example, if the user is a clerk, as exemplarily determined by the entered password, the process 1500 advances to stage 1512A. On the other hand, if the user is a manager, as exemplarily determined by the entered password, the process 1500 advances to stage 1512B.

With reference first to the case where the user is a clerk, the displayed report decision screen defaults to a configuration where only an end-of-shift report can be accessed and printed. At this point, the clerk can elect either to print the report, or cancel the report request. If the clerk elects to cancel the report request, the process 1500 moves to stage 1514A when the clerk selects the ‘cancel’ key of the terminal. At stage 1516A, the process 1500 resets by displaying the ‘all product’ screen.

In the event that the clerk elects to print the requested report, the process 1500 moves from stage 1512A to stage 1518A when the clerk selects the ‘print’ key of the terminal. Upon selection of the ‘print’ key by the clerk, the process 1500 advances to stage 1520A where the print screen displays instructions for printing the requested report. Exemplarily, such instructions simply request the clerk to insert an appropriate authorization card in order to enable printing of the report. Thus, at stage 1522A, the clerk inserts the authorization card and, at stage 1524A, the requested report is printed by the terminal. In some implementations, the process 1500 then resets by displaying the ‘all product’ screen.

As suggested above, the illustrated implementation of process 1500 proceeds somewhat differently if the user is a manager instead of a clerk, as exemplarily determined by the entered password. In particular, the process 1500 advances from stage 1500 to stage 1512B where the manager has the option to select a particular shift, as well as the further option to elect either a summary of the shift or a detailed report of the shift. After the report selections have been made by the manager, the manager can then elect either to print the report, or cancel the report request. If the user elects to cancel the report request, the process 1500 moves to stage 1514B when the user selects the ‘cancel’ key of the terminal. At stage 1516B, the process 1500 resets by displaying the ‘all product’ screen.

Should the manager elect instead to print the requested report, the process 1500 moves from stage 1512B to stage 1518B when the clerk selects the ‘print’ key of the terminal. Upon selection of the ‘print’ key by the manager, the process 1500 advances to stage 1520B where the print screen displays instructions for printing the requested report. Exemplarily, such instructions simply request the manager to insert an appropriate authorization card in order to enable printing of the report. Thus, at stage 1522B, the manager inserts the authorization card and, at stage 1524B, the requested report is printed by the terminal. In some implementations, the process 1500 then resets by displaying the ‘all product’ screen.

As noted elsewhere herein, a wide variety of reports may be defined and generated, at the terminal and/or in other locations as well, in connection with the implementation of embodiments of the invention. Thus, the process illustrated in FIG. 15, and discussed above, is exemplary only and is not intended to limit the scope of the invention in any way.

X. Aspects of Exemplary Training Processes

At least some aspects of embodiments of the invention are concerned with the implementation of interactive training for clerks, managers and others concerning prepaid services transactions and associated processes. Such training may be directed to a variety of subjects. For example, training sessions may be implemented for various transactions and related processes such as, but not limited to, selling a card, adding a new user to the system, deleting an existing user, voiding an improperly printed, or otherwise defective, card, restocking PINs, ordering products from the data center or other source, and printing reports. Moreover, the training sessions may be customized as necessary to suit the needs of a particular type of user, such as a clerk or manager, for example.

Exemplarily, such training is implemented by way of the terminal and can be initiated by a user at any time. Thus, one aspect of embodiments of the invention is that the trainee need not attend a training class at a training facility remote from the merchant location, but can instead receive all the necessary training at the worksite. Moreover, because training is available at the terminal on an on-demand basis, training sessions can be conducted at the convenience of the trainee. This also enables merchants to maintain an adequately trained workforce, notwithstanding the relatively rapid turnover rates commonly associated with convenience store clerks and similar types of workers.

Further, the training sessions are configured to be directed only to those products available through the particular terminal or terminals in conjunction with which the training is conducted. Thus, the training is relatively focused and the trainee is not required to expend time learning about products or services not offered at the particular location where the trainee is employed. As noted earlier, such functionality is achieved, at least in part, by the ability of the data center and terminal to communicate in real time, thereby permitting updates to products and associated training to be implemented in real time. Of course, such updates may be implemented in other than real time modes as well.

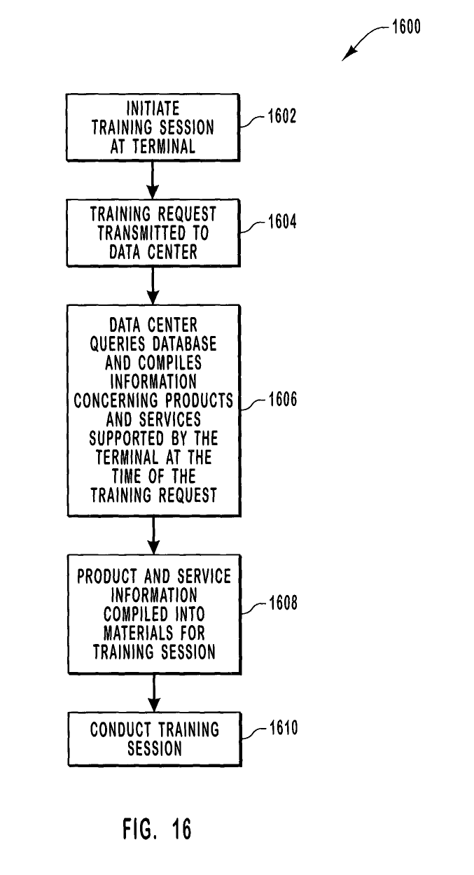

With the foregoing in view, attention is directed now to FIG. 16 where various general aspects concerning an exemplary training procedure 1600 are presented. The process 1600 commences at stage 1602 where a user initiates a training session at the terminal. Initiation of the training session causes the process 1600 to advance to stage 1604 where a training request is transmitted from the terminal to the communications server of the data center. If the communications server determines that the training request is valid, the process then advances to stage 1606 where the communications center, acting in response to a valid training request received from the terminal, queries the data center database or, alternatively, a host database, for information concerning the product and service mix supported by the requesting terminal at the time the request was made. The database reports module of the data center then assembles any such information identified.

At such time as the available information has been thus assembled, the process 1600 advances to stage 1608 where such information is then compiled into materials directed to the requested training session. Such materials may include, among other things, interactive training screens and training scripts directed to the product and service mix supported by the requesting terminal. Such training scripts may be supplied to the manager in hardcopy form and/or may be displayed by the terminal. Upon compilation of such materials, the process 1600 moves to stage 1610 where the requested training session is conducted.

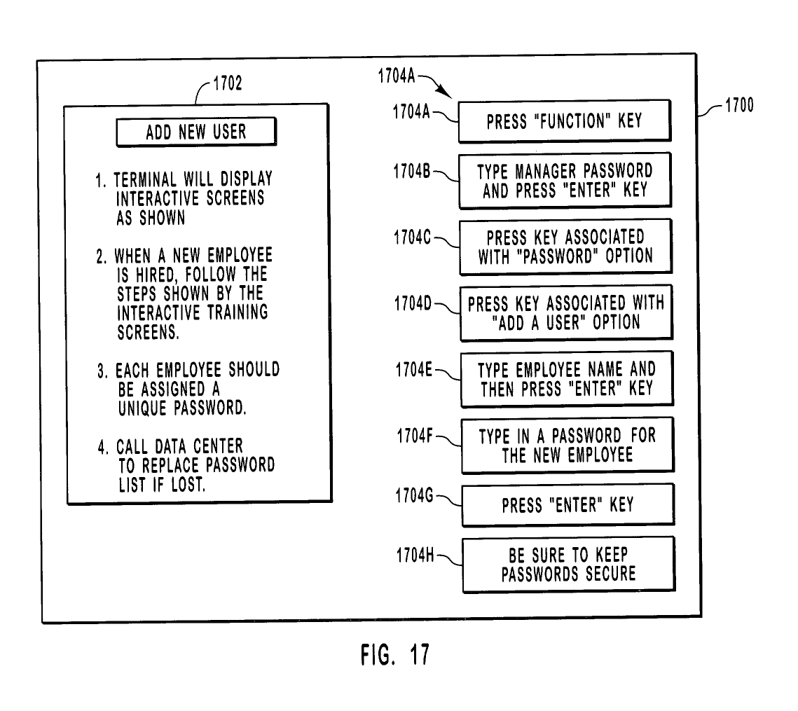

With attention now to FIG. 17, details are provided concerning aspects of one exemplary training session that concerns a situation wherein a manager desires to authorize a new user, such as a new employee, to perform various operations and processes using the terminal. The exemplary implementation illustrated in FIG. 17 makes use of both training scripts and interactive training screens.

More particularly, training instructions 1700 are provided that exemplarily include a training script 1702 and various screen displays 1704. Generally, the training script 1702 provides background information and general instructions to the trainee concerning a particular training process, while the illustrated screen displays 1704 indicate, in step-by-step fashion for example, the corresponding interactive training screens that will appear on the terminal display.

Thus, the illustrated exemplary training script 1702 is an “Add New User” training script that indicates to the trainee that “1. The terminal will display interactive training screens as shown [in the exemplary screen displays 1704]; 2. When a new employee is hired, follow the steps shown by the interactive training screens; 3. Each employee should be assigned a unique password; and 4. Call data center to replace password list if lost.” Thus, item 1. of this exemplary training script 1702 informs the trainee as to what should be expected concerning the interactive training screens displayed by the terminal, while items 2. and 3. provide the trainee with general instructions and considerations concerning the training process. Lastly, item 4. of the exemplary training script 1702 provides instructions concerning an issue implicated by the training process.

As the foregoing thus suggests, the training script 1702 may contain a variety of information and instructions, either or both of which may be general or specific, concerning a particular training process. Thus, the illustrated training script 1702 is simply one exemplary implementation and should not be construed to limit the scope of the invention in any way. More generally, training scripts may be devised to address any training process relating to the performance, by clerks, managers or other personnel, of various transactions, operations and processes using the terminal.

With continuing reference now to FIG. 17, the various illustrated screen displays 1704 employed in conjunction with the training script 1702 serve to aid the trainee in navigating through the training process on the terminal. Thus, the screens 1704A and 1704B will prompt the trainee to, respectively, press the ‘function’ key, and then type the manager password and press the ‘enter’ key. Upon entry of a valid manager password, screen 1704C is displayed that prompts the trainee to press the terminal key associated with the ‘password’ option. After the trainee has selected such key, screen 1704D prompts the trainee to press the terminal key associated with the ‘add a user’ option. Selection of the ‘add a user’ option key causes the terminal to display screen 1704E which prompts the trainee to type in the name of the new employee and to press the ‘enter’ key after the new employee name has been typed. At this point, screen 1704F is displayed that requests the trainee to type in a password for the new employee. The format of the password can be defined in any suitable way. In one exemplary implementation, a five digit password signifies that the new user is a manager, while a four digit password indicates that the new user is a clerk. Upon entry of the password, screen 1704G is displayed, prompting the trainee to press the ‘enter’ key. At such time as the ‘enter’ key has been pressed, the new user name is associated with the entered password and the new user is listed at the terminal and/or the data center as an authorized user.

In some implementations, a final screen display 1704H is presented that reminds the trainee to keep the newly entered password secure. Thus, the various screen displays 1704, like the training scripts 1702, may present both instructions and information, either or both of which may be general or specific, concerning a particular training process.

As in the case of the illustrated exemplary training script 1702, the screen displays 1704 indicated in FIG. 17 simply represent one exemplary implementation of screen displays such as may be employed in connection with a training process implemented by way of the terminal, and such exemplary screen displays should not be construed to limit the scope of the invention in any way. More generally, screen displays and combinations thereof may be devised to address any training process relating to the performance, by clerks, managers or other personnel, of various transactions, operations and processes using the terminal.

XI. Aspects of Exemplary Hardware and Software, and Associated Configurations

As suggested earlier, embodiments of the present invention may be implemented in connection with environments that include a variety of systems, devices, hardware and software. More detailed information is now provided concerning exemplary hardware and software, and related configurations, that may be used to implement one or more aspects of embodiments of the invention. Embodiments within the scope of the present invention also include computer-readable media for carrying or having computer-executable instructions or electronic content structures stored thereon. Such computer-readable media can be any available media which can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or electronic content structures and which can be accessed by a general purpose or special purpose computer.

When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and content that cause a general purpose computer, special purpose computer, or special purpose processing device to perform a certain function or group of functions.

The following discussion is intended to provide a brief, general description of an exemplary computing environment in which the invention may be implemented. Although not required, aspects of the invention may be described in the general context of computer-executable instructions, such as program modules, being executed by computers in network environments. Generally, program modules include routines, programs, objects, components, and content structures that perform particular tasks or implement particular abstract content types. Computer-executable instructions, associated content structures, and program modules represent examples of the program code means for executing steps of the methods disclosed EM herein. The particular sequence of such executable instructions or associated content structures represent examples of corresponding acts for implementing the functions described in such steps.

Of course, the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a client network. In a distributed computing environment for example, program modules may be located in both local and remote memory storage devices.

The described embodiments are to be considered in all respects only as exemplary and not restrictive. The scope of the invention is, therefore, indicated by the appended claims rather than by the foregoing description. All changes which come within the meaning and range of equivalency of the claims are to be embraced within their scope.

What is claimed is:

1. A terminal for use in a client-server environment for facilitating prepaid service product transactions and related processes, wherein the terminal comprises:
a housing having front and back sides;
electronic circuitry substantially disposed within the housing;
a keypad in communication with at least some of the electronic circuitry and located proximate the front side of the housing;
communications hardware in communication with at least some of the electronic circuitry;
an interface display in communication with at least some of the electronic circuitry and located proximate the front side of the housing; and
a media display in communication with at least some of the electronic circuitry and located proximate the back side of the housing.

2. The terminal as recited in claim 1, wherein the keypad comprises:
a plurality of number keys;
at least one navigation key; and
at least one function key.

3. The terminal as recited in claim 1, wherein the electronic circuitry includes at least one of: flash memory; RAM; and, an internal modem.

4. The terminal as recited in claim 1, wherein the communications hardware comprises a telephone line connection.

5. The terminal as recited in claim 1, wherein the communications hardware comprises a wireless communication connection.

6. The terminal as recited in claim 1, wherein the interface display comprises a four line by forty character LCD.

7. The terminal as recited in claim 6, wherein the four line by forty character LCD comprises a non-backlit ASCII LCD.

8. The terminal as recited in claim 1, wherein the interface display comprises an eight bit parallel interface.

9. The terminal as recited in claim 1, wherein the media display comprises a four line by forty character display.

10. The terminal as recited in claim 9, wherein the media display comprises an FVD.

11. The terminal as recited in claim 9, wherein the media display comprises an LCD.

12. The terminal as recited in claim 1, wherein the media display is programmable.

13. The terminal as recited in claim 1, wherein the media display provides at least one of the following functionalities: scrolling; flashing; and top-to-bottom movement.

14. The terminal as recited in claim 1, further comprising at least one of the following components in communication with at least some of the electronic circuitry: a thermal printer; a magswipe card reader; and, a barcode scanner.

15. The terminal as recited in claim 1, wherein the terminal is compatible with at least one of the following communication methodologies: batch communication; real time communication; and, just-in-time communication.

16. The terminal as recited in claim 1, wherein the terminal is compatible with at least one of the following environments: single cash register; and, EPOS.

17. The terminal as recited in claim 1, wherein the terminal is configured to facilitate implementation of prepaid service transactions of at least one of the following types: PIN-based transactions; and, PIN-less transactions.

18. A terminal for use in a client-server environment for facilitating prepaid service product transactions and related processes, wherein the terminal comprises:
a housing having front and back sides;
electronic circuitry substantially disposed within the housing;
a keypad in communication with at least some of the electronic circuitry and located proximate the front side of the housing, the keypad including a plurality of number keys, at least one navigation key, and at least one function key;
a telephone line connection in communication with at least some of the electronic circuitry;
a thermal printer in communication with at least some of the electronic circuitry;
a magswipe card reader in communication with at least some of the electronic circuitry;
a four line by forty character LCD interface display in communication with at least some of the electronic circuitry and located proximate the front side of the housing; and
a programmable four line by forty character FVD media display in communication with at least some of the electronic circuitry and located proximate the back side of the housing.

19. The terminal as recited in claim 18, wherein the electronic circuitry includes at least one of: flash memory; RAM; and, an internal modem.

20. The terminal as recited in claim 18, wherein the programmable four line by forty character FVD media display provides at least one of the following functionalities: scrolling; flashing; and top-to-bottom movement.

21. The terminal as recited in claim 18, further comprising a barcode scanner in communication with at least some of the electronic circuitry.

22. The terminal as recited in claim 18, wherein the terminal is compatible with at least one of the following communication methodologies: batch communication; real time communication; and, just-in-time communication.

23. The terminal as recited in claim 18, wherein the terminal is compatible with at least one of the following environments: single cash register; and, EPOS.

24. The terminal as recited in claim 18, wherein the terminal is configured to facilitate implementation of prepaid service transactions of at least one of the following types: PIN-based transactions; and, PIN-less transactions.
